(19) United States
(12) Patent Application Publication
(10) Pub. No.: US 2023/0196466 A1
(43) Pub. Date: Jun. 22, 2023

(54) SYSTEMS, METHODS, AND PROGRAMS FOR SUPPORTING PORTFOLIO CONSTRUCTION

(71) Applicants: Yasuhiro Kawakami, Tokyo (JP); Soh Kaijima, Kawasaki-shi (JP); Kimihiro Saitoh, Yamato-shi (JP)

(72) Inventors: Yasuhiro Kawakami, Tokyo (JP); Soh Kaijima, Kawasaki-shi (JP); Kimihiro Saitoh, Yamato-shi (JP)

(21) Appl. No.: 18/083,613

(22) Filed: Dec. 19, 2022

(30) Foreign Application Priority Data
Dec. 18, 2021 (JP) 2021-205623

(51) Int. Cl. G06Q 40/06

(52) U.S. Cl. CPC G06Q 40/06

(57) ABSTRACT

There is provided a method performed by a processor. The method comprises: showing a set of security candidates on a display device; receiving from an input device a selection input indicating a selection of two or more securities to be added to an ideal portfolio from the set of security candidates; adding the two or more securities to the ideal portfolio; determining an ideal allocation for the ideal portfolio such that an ideal expectation of return of the ideal portfolio and an ideal risk value indicating a magnitude of variation in the return of the ideal portfolio satisfy a predefined condition; and showing the ideal allocation on the display device.

### CROSS REFERENCE TO RELATED APPLICATIONS

This application is entitled to and claims the benefit of Japanese Patent Application No. 2021-205623 filed on Dec. 18, 2021, the disclosure of which including the specification, drawings and abstract is incorporated herein by reference in its entirety.

### TECHNICAL FIELD

The present invention relates to the construction and optimization of a portfolio of assets.

### BACKGROUND ART

A portfolio (hereinafter simply referred to as a portfolio) is a collection of assets (hereinafter referred to as component assets). Each component asset can be identified by at least one currency (hereafter referred to as component currency) and/or at least one security (hereafter referred to as component security) such as stock, bond, ITF (investment trust fund), ETF (exchange-traded fund), and a quantity thereof. An asset allocation of a portfolio can be identified by a combination of component assets and their respective ratios of valuation to their total valuation. Each component asset valuation may be calculated by multiplying a price per unit of the component currency or security by the quantity thereof. The price per unit may be a traded price or a last traded price per unit expressed in terms of one currency (hereinafter referred to as a reference currency).

### SUMMARY OF INVENTION

### Technical Problem

The return of a portfolio that can be realized in the future will significantly depend on the asset allocation of the portfolio. Thus it is preferable to optimize the asset allocation as much as possible, for example, to attain a higher expectation of return with a tolerable volatility.

### Solution to Problem

According to a first aspect, a method performed by a processor is provided. The method comprises: showing a set of security candidates on a display device; receiving from an input device a selection input indicating a selection of two or more securities to be added to an ideal portfolio from the set of security candidates; adding the two or more securities to the ideal portfolio; determining an ideal allocation for the ideal portfolio such that an ideal expectation of return of the ideal portfolio and an ideal risk value indicating a magnitude of variation in the return of the ideal portfolio satisfy a predefined condition; and showing the ideal allocation on the display device.

According to a second aspect, a method is provided according to the first aspect, wherein the ideal expectation of return and the ideal risk value are calculated using respective actual expectations of return of the two or more securities, respective actual risk values indicating a magnitude of variation in the return of the two or more securities, and first coefficients indicating joint variability in the respective returns of the two or more securities, wherein the actual expectations of return, the actual risk values, and the first coefficients are calculated using historical price data of the two or more securities.

According to a third aspect, a method is provided according to the second aspect, wherein the first coefficients comprise one of (i) elements of a variance-covariance matrix calculated using historical price data of the two or more securities and (ii) elements of a correlation matrix calculated using historical price data of the two or more securities.

According to a fourth aspect, a method is provided according to the first aspect, further comprising: receiving from the input device at least one of a specified expectation input indicating a specified expectation of return and a specified risk value input indicating a specified risk value, for at least one of the two or more securities, wherein the ideal expectation of return and the ideal risk value are calculated using (i) the specified expectation of return for the at least one of the two or more securities, (ii) the specified risk value for the at least one of the two or more securities, (iii) respective actual expectations of return of the two or more securities for which the specified expectation of return is not inputted, (iv) respective actual risk values indicating a magnitude of variation in the return of the two or more securities for which the specified risk value is not inputted, and (v) second coefficients indicating joint variability in the returns of the two or more securities, wherein the actual expectations of return, the actual risk values, and the second coefficients are calculated using historical price data of the two or more securities.

According to a fifth aspect, a method is provided according to the fourth aspect, wherein the second coefficients comprise elements of a correlation matrix calculated using historical price data of the two or more securities.

According to a sixth aspect, a method is provided according to the fifth aspect, wherein the ideal risk value comprises one of a standard deviation of return and a downward standard deviation of return.

According to a seventh aspect, a method is provided according to the first aspect, wherein the predefined condition is one of (i) the ideal expectation of return is maximized under a condition that the ideal risk value is within a predetermined range and (ii) the ideal risk value is minimized under a condition that the ideal expectation of return is within a predetermined range.

According to an eighth aspect, a method is provided according to the first aspect, wherein the predefined condition is a condition that a value of a function is maximized or minimized for the ideal expectation of return and the ideal first risk within respective predetermined ranges.

According to a ninth aspect, a method is provided according to the eighth aspect, wherein the function is a Sharpe ratio whose value is calculated from the ideal expectation of return and the ideal risk value.

According to a tenth aspect, a method is provided according to the first aspect, further comprising: for two or more attributes of security candidates, rendering on the display device two or more pairs of a distribution histogram of a set of security candidates and a user interface, each pair corresponding to an attribute of the two or more attributes, the distribution histogram of each pair being a distribution histogram over a value of the attribute corresponding to the pair, the user interface of each pair being configured to show a range of values of the attribute corresponding to the pair, the range being specified in response to a range input by the user on the input device; in response to the range having been specified, updating the set of security candidates by extracting security candidates that satisfy a condition that, for an attribute of each pair of the two or more pairs, the value of the attribute of the security candidates is within the specified range of values of the attribute; and updating the distribution histogram on the display device for each pair of the two or more pairs.

According to an eleventh aspect, a method is provided according to the tenth aspect, wherein the user interface comprises a range slider having two sliders that can be manipulated by a user to input a range input, wherein the two or more attributes comprise at least one of a market capitalization, a correlation coefficient, a Sharpe ratio, an annualized return, and an annualized volatility.

According to a twelfth aspect, a method is provided according to the first aspect, further comprising: receiving a quantity input indicating a currency quantity; updating a currency quantity of a current portfolio with the currency quantity indicated by the quantity input; and initializing the ideal portfolio with the current portfolio.

According to a thirteenth aspect, a method is provided according to the twelfth aspect, further comprising: receiving an investor identification input identifying an investor; receiving a portfolio identification input identifying portfolio information that is associated with the investor; loading the portfolio information from a memory; and initializing the current portfolio using the portfolio information.

According to a fourteenth aspect, a method is provided according to the thirteenth aspect, further comprising: initializing new portfolio with the ideal portfolio; receiving a ratio input indicating a ratio of an asset valuation for one of the two or more securities; updating the new portfolio such that the ratio of the asset valuation of the one of the two or more securities to the valuation of the new portfolio is equal to the ratio indicated by the ratio input; and showing new allocation of the new portfolio on the display device.

According to a fifteenth aspect, a method is provided according to the fourteenth aspect, wherein, when the asset valuation of the one of the two or more securities decreases in the updating, updating a currency asset valuation of the new portfolio such that the total valuation of the new portfolio is unchanged.

According to a sixteenth aspect, a method is provided according to the fourteenth aspect, further comprising: storing portfolio information indicating the new portfolio in a memory with associating with an investor.

According to a seventeenth aspect, a method is provided according to the first aspect, wherein the ideal allocation is determined by: calculating pairs of an expectation of return and a risk value, respectively for randomly generated allocations for the two or more securities; and selecting a pair from the pairs that satisfies the predefined condition as a pair of the ideal expectation of return and the ideal risk value.

According to an eighteenth aspect, a method is provided according to the sixteenth aspect, further comprising: rendering an effective frontier chart using the pairs of an expectation of return and a risk value.

According to a fifteenth aspect, a system is provided. The system comprises: a processor; and a non-transitory computer readable memory storing a program code configured to, when executed by the processor, cause the processor to perform a method comprising: showing a set of security candidates on a display device; receiving from an input device a selection input indicating a selection of two or more securities to be added to an ideal portfolio from the set of security candidates; adding the two or more securities to the ideal portfolio; determining an ideal allocation for the ideal portfolio such that an ideal expectation of return of the ideal portfolio and an ideal risk value indicating a magnitude of variation in the return of the ideal portfolio satisfy a predefined condition; and showing the ideal allocation on the display device.

According to a twentieth aspect, a computer program product is provided. The computer program product comprises: a non-transitory computer readable medium having a program code embodied therein configured to, when executed by a processor, cause the processor to perform a method comprising: showing a set of security candidates on a display device; receiving from an input device a selection input indicating a selection of two or more securities to be added to an ideal portfolio from the set of security candidates; adding the two or more securities to the ideal portfolio; determining an ideal allocation for the ideal portfolio such that an ideal expectation of return of the ideal portfolio and an ideal risk value indicating a magnitude of variation in the return of the ideal portfolio satisfy a predefined condition; and showing the ideal allocation on the display device.

### BRIEF DESCRIPTION OF DRAWINGS

FIG. 1 shows a configuration of a system for supporting portfolio construction according to an exemplary embodiment of the present application;

FIG. 2 shows an operation flow diagram of systems, methods and programs for supporting portfolio construction according to an exemplary embodiment of the present application;

FIG. 3 shows an example of an operation flow diagram executed by controller 1120 of client 1100 in step S2005 of FIG. 2;

FIG. 4A shows an example of a screen image displayed by controller 1120 on display and input device 1110 in step S2010 of FIG. 3;

FIG. 4B shows an example of a screen image displayed by controller 1120 on display and input device 1110 in steps S2040 and S2060 of FIG. 3;

FIG. 5 shows an example of an operation flow diagram executed by controller 1120 of client 1100 in step S2080 of FIG. 2;

FIG. 6A shows an example of a screen image displayed on display and input device 1110 by controller 1120 in step S5010 of FIG. 5;

FIG. 6B shows an example of a screen image displayed by controller 1120 on display and input device 1110 in step S5040 of FIG. 5;

FIG. 6C shows an example of a screen image displayed by controller 1120 on display and input device 1110 in step S5010 of FIG. 5 after step S5040;

FIG. 7A shows an example of an operation flow diagram executed by controller 1120 of client 1100 in step S2090 of FIG. 2;

FIG. 7B shows an example of an operation flow diagram executed by controller 1120 of client 1100 in steps S7070 and steps S7080 of FIG. 7A;

FIG. 8A shows an example of a screen image displayed on display and input device 1110 by controller 1120 in step S7040 of FIG. 7A;

FIG. 8B shows a further example of a screen displayed by controller 1120 on display and input device 1110 in step S7050 of FIG. 7A;

FIG. 8C shows an example of a screen image displayed by controller 1120 on display and input device 1110 in step S7210 of FIG. 7A;

FIG. 8D shows an example of a screen image displayed by controller 1120 on display and input device 1110 in step S7240 of FIG. 7B;

FIG. 8E shows an example of a screen image displayed by controller 1120 on display and input device 1110 in step S7210 after step S7260 of FIG. 7B;

FIG. 8F shows an example of a screen image displayed by controller 1120 on display and input device 1110 in step S7040 of FIG. 7A after returning from step S7070 of FIG. 7A;

FIG. 8G shows an example of a screen image displayed by controller 1120 on display and input device 1110 in step S7210 after step S7260 of FIG. 7B;

FIG. 8H shows an example of a screen image displayed by controller 1120 on display and input device 1110 in step S7040 after returning from step S7080 of FIG. 7A;

FIG. 8I shows an example of a screen image displayed by controller 1120 on display and input device 1110 in step S7090 of FIG. 7A;

FIG. 8J shows an example of a screen image displayed by controller 1120 on display and input device 1110 in step S7040 of FIG. 7A after step S7090;

FIG. 8K shows another example of a screen image displayed on display and input device 1110 by controller 1120 in step S7040 of FIG. 7A;

FIG. 8L shows an example of a screen image displayed by controller 1120 on display and input device 1110 in step S7095 of FIG. 7A;

FIG. 8M shows an example of a screen image displayed by controller 1120 on display and input device 1110 in step S7040 of FIG. 7A after step S7095;

FIG. 8N shows an example of a screen image displayed by controller 1120 on display and input device 1110 in step S7100 of FIG. 7A;

FIG. 8O shows an example of a screen image displayed by controller 1120 on display and input device 1110 in step S7040 of FIG. 7A after step S7100;

FIG. 8P shows an example of a screen image displayed by controller 1120 on display and input device 1110 in step S7105 of FIG. 7A;

FIG. 8Q and FIG. 8R show an example of a screen image displayed by controller 1120 on display and input device 1110 in step S7110 of FIG. 7A;

FIG. 9 shows an example of an operation flow diagram executed by controller 1120 of client 1100 in step S7250 of FIG. 7B;

FIG. 10 shows an example of a screen image displayed on display and input device 1110 by controller 1120 in step S9010 of FIG. 9; and

FIGS. 11A, 11B, and 11C show another example of a screen image displayed on display and input device 1110 by controller 1120 in step S9010 of FIG. 9.

### DESCRIPTION OF EMBODIMENTS

Hereinafter, a configuration of an embodiment according to the present invention will be described with reference to the drawings.

<System Configuration Example>

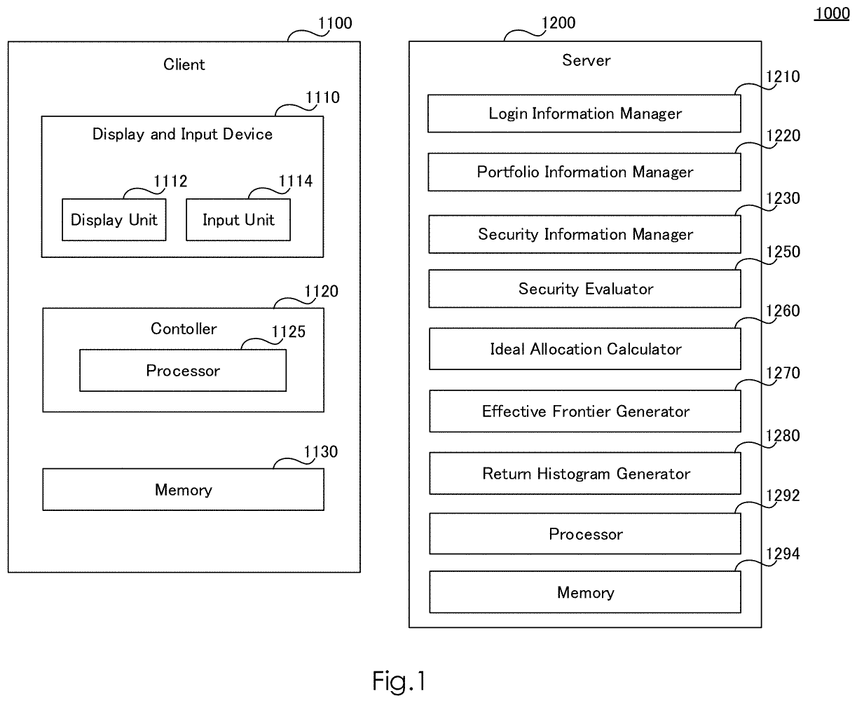

FIG. 1 shows a configuration of a system for supporting portfolio construction according to an exemplary embodiment of the present application. The system for supporting portfolio construction (system) 1000 includes client computer (client) 1100 and server computer (server) 1200.

Client 1100 and server 1200 are communicatively connected by wired or wireless means, where one component can send or receive data or information from the other component via wired or wireless communication. Wired communications are established, for example, include using Ethernet protocols over metal wires or fiber optics. Wireless communications include, for example, Wi-Fi, Bluetooth, 3G, 4G, and 5G communications. In the embodiments described hereinafter, while client 1100 and server 1200 are depicted as separate hardware devices, client 1100 and server 1200 may be the same hardware device in some other embodiments. When client 1100 and server 1200 are the same hardware device, the description provided hereinafter may be applied, for example, by interpreting wired or wireless communications as intra-processor communications or inter-processor communications.

Client 1100 includes display and input device 1110, controller 1120, and memory 1130. For example, client 1100 may be a smartphone, a tablet device, or a personal computer.

Display and input device 1110 includes display unit 1112 and input unit 1114. The operations of display unit 1112 or input unit 1114 are described hereinafter assuming that client 1100 is a smartphone or a tablet device, in which unit 1112 and input unit 1114 are integratedly installed in the same device. However, the operations of display and input device 1110 described hereinafter can be performed by display unit 1112 and input unit 1114 that are separately installed in different devices.

Display unit 1112 is operable to display information to a user of client 1100. In one example, display unit 1112 may be a liquid crystal display (LCD) or an organic light emitting display (OLED) that is wired or wirelessly connected to controller 1120, for example, via a video memory to store visual data representing the information. The visual data may be data representing a screen image. In another example, display unit 1112 may be an audio display device or an audio display device that is wired or wirelessly connected to controller 1120, for example, via an audio memory to store audio data representing the information, and provides an audio display or an audio output by playing the audio data on loudspeakers or earphones. Input unit 1114 is operable to receive an input from a user of client 1100 and sends information indicating the input to controller 1120. For example, when client 1100 is a smartphone or a tablet device, input unit 1114 may be a projected capacitive touch panel or a resistive touch panel that is wired or wirelessly connected to controller 1120. For example, when client 1100 is a personal computer, input unit 1114 may be a keyboard device and/or a mouse device that are/is wired or wirelessly connected to controller 1120.

Controller 1120 controls the operations of client 1100. Controller 1120 shows information on display unit 1112, for example, by storing visual data representing the information in a video memory and/or by storing audio data representing the information in an audio memory. Controller 1120 receives an input from input unit 1114 of display and input device 1110. When input unit 1114 includes a touch panel, and in response to detecting a touch thereon, input unit 1114 sends information indicating the touched position to controller 1120. When the input unit 1114 includes a keyboard, and in response to detecting a press on a key of the keyboard, input unit 1114 sends information indicating the pressed key to the controller 1120. When the input unit 1114 includes a mouse device, and in response to detecting a click or tap of a button of the mouse device, input unit 1114 sends information indicating the click or tap to the controller 1120.

Controller 1120 may detect a click or tap by receiving the information sent from input unit 1114 and may determine the type of input based on the information sent from input unit 1114 and control information used by controller 1120 to show a screen image on the display unit 1112. The control information is, for example, information indicating a position and/or a status of each widget included in a screen displayed on display unit 1112. The widget may be, for example, a button widget (or simply referred to as a button), a label widget (or simply referred to as a label), a field widget (or simply referred to as a field), a combo box widget (or simply referred to as a combo box), or a checkbox widget (or simply referred to as a checkbox), or a range slider widget (or simply referred to as a range slider). In one example embodiment, controller 1120 can detect a click or tap by a user on any one of a button widget, a label widget, a field widget, a combo box widget, a checkbox widget, and a range slider widget; controller 1120 can show a text on any one of a button widget, a label widget, and a field widget; controller 1120 can receive a text input from a field widget; controller 1120 can show menu items having respective labels on a combo box widget and receive a selection of a menu item which has been selected by a user from the menu items on the combo box widget; controller 1120 can flip the status of a checkbox widget between selected and deselected in response to a detection of a tap or click on the checkbox, and receive information indicating the status from the checkbox widget; a slider widget includes a track and at least two sliders that can be manipulated to move on the track by a user, and controller 1120 can receive information indicating the positions of the sliders in response to a detection of movement of at least one of the sliders. For example, in the Flutter™ framework, one of the well-known software development frameworks, a button widget, a label widget, a field widget, a combo box widget, a checkbox widget and a range slider are, respectively realized using, for example, the ElevatedButton class, the Text class, the TextFormField class, the DropdownButton class, the Checkbox class, and the RangeSlider class.

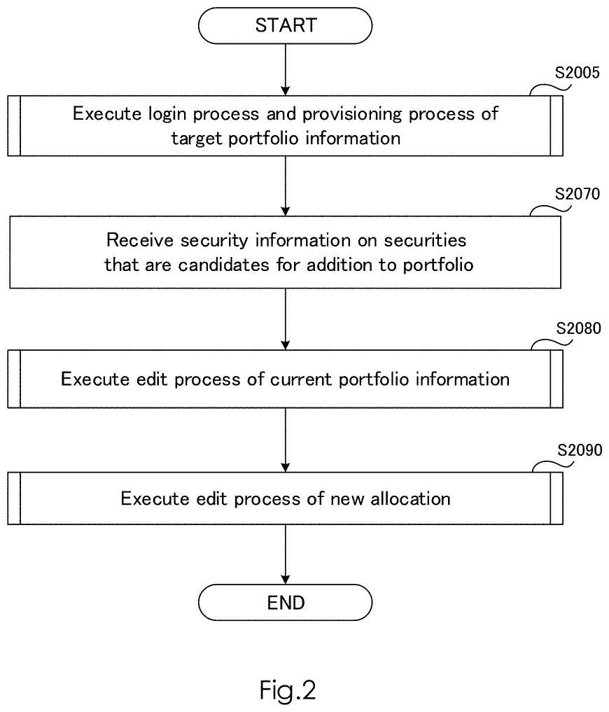

Controller 1120 includes processor 1125. Processor 1125 may include, for example, at least one of a central processing unit (CPU), a graphics processing unit (GPU), an application specific integrated circuit (ASIC), and a field programmable gate array (FPGA). A program stored in memory 1130 may be read and executed by processor 1125 to realize the functions of controller 1120 described herein with referring to the flow diagrams depicted in FIGS. 2, 3, 5, 7A, 7B, and 9. In one example, the programs described herein may be embodied in a non-transitory computer readable medium or media of a computer program product, and the instructions included in the program, when executed by a processor, cause the processor to execute aspects of the present invention.

Memory 1130 is connected to controller 1120, stores data or information received from controller 1120, and sends the stored data or information to controller 1120 upon request from controller 1120. Memory 1130 may include a video memory and/or an audio memory. Memory 1130 may include, for example, at least one of a volatile memory device such as a dynamic random access memory (DRAM) device, a static random access memory (SRAM) device, and a non-volatile memory device such as a read-only memory (ROM) device, a flash memory device, a hard disk drive, a magnetic tape device, an optical memory device, a magnetic or magnetoresistive random access memory (MRAM) device, a resistive random access memory (ReRAM) device, a phase-change memory (PCM) device.

Server 1200 includes login information manager 1210, portfolio information manager 1220, security information manager 1230, security evaluator 1250, ideal allocation calculator 1260, effective frontier generator 1270, return histogram generator 1280, processor 1292, and memory 1294. Login information manager 1210, portfolio information manager 1220, security information manager 1230, security evaluator 1250, ideal allocation calculator 1260, effective frontier generator 1270, and return histogram generator 1280 may send information to and/or receive information from controller 1120 via a wired or wireless connection. Further, the components may exchange data or information among them via a wired or wireless connection.

Login information manager 1210 stores login information for all users that are allowed to log in to system 1000. A user may be, for example, an independent financial advisor (IFA), an investment advisor, or an investor. The login information may be any information that can identify a user using system 1000, for example, a combination of the user's email address and password. In one example, when the user is an investor, login information manager 1210 may store investor identification information that identifies the user as an investor. In another example, when the user is an IFA or an investment advisor, login information manager 1210 may store investor identification information that identifies each of one or more investors that the user is in charge of.

For each investor, portfolio information manager 1220 stores portfolio identifier list information indicating a list of portfolio identifiers and associated with investor identification information identifying the investor. In response to receiving investor identification information from controller 1120, portfolio information manager 1220 sends portfolio identifier list information to controller 1120. The portfolio identifiers may be any identifier that can uniquely identify portfolio information indicating a portfolio of the investor indicated by the associated investor identification information. For example, each portfolio identifier may contain a concatenated string including a name of investor and a name of portfolio. Further, in response to receiving information indicating a portfolio identifier, portfolio information manager 1220 sends portfolio information indicating the portfolio uniquely identified by the portfolio identifier to controller 1120. Portfolio information manager 1220 may store portfolio identifier list information and portfolio information in a non-volatile memory included in memory 1294 and load them from the non-volatile memory.

Portfolio information is information indicating a portfolio containing component assets, which is represented by a combination of information indicating each component asset contained in the portfolio, for example, as shown in <Table 1> or <Table 2> provided below. The information indicating each component asset may include information indicating a component currency or a component security and information indicating the quantity of the component currency or the component security, as shown in Table 1 provided below. Alternatively, or in addition, the information indicating each component asset may include information indicating a component currency or a component security and information indicating a ratio of the component asset valuation to the total portfolio valuation, as shown in Table 2 provided below. The ratio may be expressed as a real number between 0 and 1, inclusive, or as a percentage between 0% and 100%, inclusive. In one example embodiment, the information indicating each component asset may further include information indicating a price per unit of the component currency or the component security. The prices (per unit) described herein are prices (per unit) expressed in terms of a reference currency. The reference currency used herein may be any currency, for example, Japanese yen, US dollar, euro.

TABLE 1
Portfolio information example

| | Component currency/security | Holding quantity | |
|---|---|---|---|
| Component asset 1 | Japanese yen (JPY) | JPY 10,000,000 | |
| Component asset 2 | US dollar (USD) | USD 30,000 | |
| Component asset 3 | ITF A | 5,000,000 | unit(s) |
| Component asset 4 | ITF B | 3,000,000 | unit(s) |
| Component asset 5 | stock C | 2,000 | share(s) |

TABLE 2
Portfolio information example

| | Component currency/security | Ratio |
|---|---|---|
| Component asset 1 | Japanese yen (JPY) | 20% |
| Component asset 2 | US dollar (USD) | 10% |
| Component asset 3 | ITF A | 30% |
| Component asset 4 | ITF B | 25% |
| Component asset 5 | stock C | 15% |

Security information manager 1230 stores and manages profile information on securities that are candidates for addition to a portfolio. The profile information includes at least identification information of the securities. The identification information may be any information that can identify one security from other securities, for example, such as a security name, an abbreviation of a security name, a name of stock issuer, or a stock ticker symbol. Hereinafter, the present invention according to its embodiments is described using security names as an example of identification information. In one example embodiment, the profile information further indicates at least one of a price per (trading) unit, a display price (per volume unit), a last traded date, value(s) indicating return(s), value(s) indicating risk, a name of an investment trust company (an investment trust management company) that directs management of assets, a name of an issuing company (issuer), and market capitalization (or total net assets).

The value indicating a return of a security is a value that indicates a change in a price per unit of the security over a predetermined trading period. In one example embodiment, when the length of the predetermined trading period is K trading days, and the price per unit of the security on the current day is p and the price per unit before K trading days is p_{K}, (K-trading-day) return R may be calculated by R=R(K)=(p−p_{K})/p_{K}=p/p_{K}−1. In another example embodiment, (K-trading-day) return R may be calculated by R=R(K)=log(p/p_{K}). Here, for a positive number x, log(x) denotes a logarithm of the value x.

The value indicating risk (hereinafter referred to as risk value or volatility) of a security is a value that indicates the magnitude of variation in return of the security of a predetermined number of (consecutive) trading days. In one example embodiment, a risk value of a security may be a standard deviation of return of the security. In another example embodiment, a risk value of a security may be a downward standard deviation of return of the security, which is a standard deviation of downside return. For return R=R(K), downside return DR=DR (K) may be defined by DR=min {R−R_{req},0}, where R_{req} denotes a required rate of return, e.g., the risk-free rate corresponding to K trading days. An expectation of return and a risk value of a security are calculated, for example, using historical prices of the security. Here, the term “expectation” is used herein in a mathematical sense, and may be also referred to as expected value, expectancy, mathematical expectation, mean, average, or first moment. In one example embodiment, assuming that a predetermined number of trading days is a positive integer N and the (K-trading-day) return for N trading days calculated using historical prices for at least N+K (consecutive) trading days are {R₁, R₂, . . . , R_{N}}, expectation μ of (K-trading-day) return may be calculated by:

$$μ = μ ( K , N ) = \frac{1}{N} {\sum }_{n = 1}^{N} {R}_{n} ( K ) .$$

Standard deviation σ of return may be calculated by:

$$σ = σ ( K , N ) = \sqrt{\frac{1}{N} {{\sum }_{n = 1}}^{N} {( {R}_{n} ( K ) - μ ( K , N ) )}^{2}} .$$

In another example embodiment, scaled expectation \tilde{μ} defined by:

\tilde{μ}=\tilde{μ}(K,N)=Kμ(1,N)

of return and scaled standard deviation \tilde{σ} defined by:

\tilde{σ}=\tilde{σ}(K,N)=\sqrt{K}σ(1,N)

of return may be used as substitution for expectation μ=μ(K,N) and standard deviation σ=σ(K,N) of (K-trading-day) return, respectively. This scaling applies when a downward standard deviation is used. The number K may be chosen to be the number of trading days in a year or 3 years. The number of trading days in a year may be, for example, 250, 252, or 260. When K is equal to 250, 252, or 260, the scaled expectation of return may be referred to as an annualized expectation of return, and the scaled standard deviation (or the scaled downward standard deviation) of return may be referred to as an annualized volatility. The description provided herein takes a standard deviation of return of a security as an example of a risk value of the security, however the description may apply to a downward standard deviation of return of a security, as well, by replacing return R, Rₙ, or Rₙ⁽ⁱ⁾ with downside return DR, DRₙ=min{Rₙ−R_{req},0}, or DRₙ⁽ⁱ⁾=min{Rₙ⁽ⁱ⁾−R_{req},0} in the formulas provided herein when calculating a downward standard deviation, and by using return R, Rₙ, or Rₙ⁽ⁱ⁾ in the formulas provided herein when calculating an expectation.

Furthermore, security information manager 1230 stores and manages historical information on securities that are candidates for addition to a portfolio. The historical information includes information indicating historical prices per unit of each security. Security information manager 1230 may send profile information and/or historical information to controller 1120, effective frontier generator 1270, and/or return histogram generator 1280, upon a request from controller 1120, effective frontier generator 1270, and/or return histogram generator 1280.

Security evaluator 1250 ranks securities that are candidates for addition to a portfolio based on information on a portfolio owner, information on other investors, and statistics on the investment targets, and generates ranking information. Table 3 provided below shows an example of ranking information. Artificial intelligence (AI) technology may be used to rank securities. The information on a portfolio owner may be, for example, the owner's risk tolerance. The information on other investors may be, for example, portfolio information of other investors whose risk tolerance deviation from the owner's risk tolerance is within a predetermined range. The investment statistics are, for example, the Sharpe ratio and the trend of risk values. For expectation μ of return and risk value σ of a security, and the Sharpe ratio SR of the security is calculated by: SR=(μ−R_{f})/σ, where R_{f} denotes a risk-free rate (e.g., an interest rate on a government bond for K trading days).

TABLE 3
Ranking information example

| Security | Sharpe ratio | Risk value | Theme | Ranking |
|---|---|---|---|---|
| ITF A | 1.25 | 15.0% | High-tech | 10 |
| ITF B | 1.50 | 18.0% | AI | 10 |
| ITF C | 1.35 | 23.0% | Small cap growth | 9 |

Ideal allocation calculator 1260 receives information indicating a combination of securities from controller 1120. Ideal allocation calculator 1260 may further receive from controller 1120 information indicating one or more constraint parameters related to expectations of return and risk values. Alternatively, or in addition, ideal allocation calculator 1260 may read information indicating one or more constraint parameters that have been stored in advance in memory 1294. The constraint parameters may be, for example, upper and/or lower limits of a risk value. Ideal allocation calculator 1260 subsequently receives from security information manager 1230 information indicating historical prices per unit of each security included in the combination of securities. The information indicating historical prices per unit may be provided in time-series data. Ideal allocation calculator 1260 subsequently generates a plurality of random allocations used in a simulation. Here, each random allocation has a combination of ratios which corresponds to the combination of securities. In each allocation, the sum of ratios is equal to one. In one example, the ratios may be all non-negative. In one example embodiment, the number of random allocations may be a predetermined number which may be any integer greater than one, e.g., 10,000, 100,000, or 1,000,000. For each random allocation, ideal allocation calculator 1260 calculates (simulates) an expectation of return and a risk value using historical prices per unit of securities. Ideal allocation calculator 1260 subsequently sends information indicating an expectation of return and a risk value calculated for each random allocation to effective frontier generator 1270.

For example, let M be an integer greater than 1. For a combination of M securities (securities 1, 2, . . . , M), when returns which are calculated using time-series data of prices per unit of security i for at least N+K trading days are {R₁⁽ⁱ⁾, R₂⁽ⁱ⁾, . . . , R_{N}⁽ⁱ⁾}, expectation μᵢ of return for security i may be calculated by:

$${μ}_{i} = {μ}_{i} ( K , N ) = \frac{1}{N} {{\sum }_{n = 1}}^{N} {R}_{n}^{( i )} ( K ) .$$

For a combination of ratios: (w₁, w₂, . . . , w_{M}) corresponding to a combination of component securities 1, 2, . . . , M of a portfolio P, expectation μ_{P} of return of portfolio P may be calculated by:

$${μ}_{P} = {μ}_{P} ( K , N ) = \frac{1}{N} {{\sum }_{n = 1}}^{N} ( {{\sum }_{i = 1}}^{M} {w}_{i} {R}_{n}^{( i )} ( K ) ) = {{\sum }_{i = 1}}^{M} {w}_{i} {μ}_{i} ( K , N ) ,$$

and risk value σ_{P} of portfolio P may be calculated by:

$$\begin{matrix}{σ}_{P} = {σ}_{P} ( K , N ) \\ = \sqrt{\frac{1}{N} {{\sum }_{n = 1}}^{N} {( {{\sum }_{i = 1}}^{M} {w}_{i} {R}_{n}^{( i )} ( K ) - {μ}_{P} ( K , N ) )}^{2}} \\ = \sqrt{\frac{1}{N} {{\sum }_{n = 1}}^{N} \{ {{\sum }_{i = 1}}^{M} {w}_{i} ( {R}_{n}^{( i )} ( K ) - {μ}_{i} ( K , N ) ) {{\sum }_{j = 1}}^{M} {w}_{j} {R}_{n}^{( j )} ( K ) - {μ}_{j} ( K , N ) ) \}} \\ = \sqrt{{w}^{T} \sum w}\end{matrix} .$$

Here, weight vector w is defined by w=(w₁, w₂, . . . , w_{M})^{T}. For vector v, v^{T} denotes a transposed vector of v. Expectation μᵢ of return is also referred to as an actual expectation of return. Risk value σᵢ is also referred to as an actual risk value. Matrix Σ is an M×M variance-covariance matrix having (i, j)-elements:

$${s}_{i , j} = {s}_{i , j} ( K , N ) = \frac{1}{N} {{\sum }_{n = 1}}^{N} ( {R}_{n}^{( i )} ( K ) - {μ}_{i} ( K , N ) ) ( {R}_{n}^{( j )} ( K ) - {μ}_{j} ( K , N ) ) .$$

The diagonal elements of matrix Σ are referred to as a variance. The off-diagonal elements of matrix Σ are referred to as a covariance. The elements of matrix Σ are one example of values indicating joint variability. In another example, scaled expectation \tilde{μ}_{P} defined by:

\tilde{μ}_{P}=\tilde{μ}_{P}(K,N)=Kμ_{P}(1,N)

and scaled standard deviation \tilde{σ}_{P} defined by:

\tilde{σ}=\tilde{σ}_{P}(K,N)=\sqrt{K}σ_{P}(1,N)

may be used as substitution for expectation μ_{P}=μ_{P}(K,N) and standard deviation σ_{P}=σ_{P}(K,N) of (K-trading-day) return, respectively. As such, for each random allocation described above, ideal allocation calculator 1260 can calculate an expectation of return and an ideal risk value using respective actual expectations of return of the securities included in the combination of securities, respective actual risk values of the securities included in the combination of securities, and the variance-covariance matrix.

Ideal allocation calculator 1260 subsequently determines an allocation which satisfies a predefined condition imposed on an expectation of return (or a modified risk value described below) and a risk value (or a modified risk value described below). For example, ideal allocation calculator 1260 determines the allocation by selecting an allocation that satisfies the predefined condition from the random allocations used in the simulation described above. In other words, the allocation is determined by calculating pairs of an expectation (or a modified expectation described below) of return and a risk value (or a modified risk value described below) for the respective random allocations and selecting an allocation whose expectation of return and risk value satisfy the predefined condition. The allocation determined here is referred to as an ideal allocation. The expectation of return and the risk value corresponding to the ideal allocation is herein referred to as an ideal expectation of return and the ideal risk value, respectively. An ideal allocation is identified by a combination of ideal ratios or ideal holding ratios each of which corresponds to a component security. In one example embodiment, the predefined condition is a constraint condition described using one or more constraint parameters. One example of such a constraint condition is the condition that an expectation of return is maximized under the condition that a risk value is within a range defined by upper and/or lower limits indicated by one or more constraint parameters. Another example of such a constraint condition is, under the condition that an expectation of return and a risk value are respectively within ranges defined by upper and/or lower limits respectively indicated by one or more constraint parameters, the condition that the value of a function of an expectation of return and a risk value is maximized or minimized. A lower limit of expectation or return may be referred to as a target expectation of return. An upper limit of risk value may be referred to as a target volatility. The function may be a monotonically decreasing or monotonically increasing function of a risk value for a fixed expectation of return and a monotonically increasing or monotonically decreasing function of an expectation of return for a fixed risk value. For example, the function may be the Sharpe ratio or the Sortino ratio. The Sharpe ratio SR_{P} of portfolio P may be calculated by:

$${SR}_{P} = \frac{{μ}_{P} - {R}_{f}}{{σ}_{P}} .$$

The Sortino ratio of portfolio P may be calculated by the same formula but replacing the standard deviation with a downward standard deviation. Another example of such a constraint condition is the condition that a risk value is minimized under the condition that an expectation of return is within a range defined by upper and/or lower limits indicated by one or more constraint parameters.

In one example, ideal allocation calculator 1260 may further modify the ideal allocation. For example, ideal allocation calculator 1260 may truncate to zero the ratios that are below a predetermined threshold and/or the quantities of component securities whose valuation is below a predetermined threshold, and further adjust the remaining ratios such that the proportions between the ratios are maintained and the sum of remaining ratios is one.

Ideal allocation calculator 1260 subsequently sends information indicating the ideal allocation to controller 1120. Further, ideal allocation calculator 1260 may send information indicating the expectation of return and the risk value corresponding to the ideal allocation to effective frontier generator 1270.

A portfolio constructed by allocating a total valuation according to the ideal allocation calculated by ideal allocation calculator 1260 is referred to as an ideal portfolio. The total valuation used here may be, for example, the total valuation of the current portfolio. An ideal portfolio may be interpreted as a “recommended portfolio” in which a total investment is allocated to respective security assets according to respective ideal ratios. For each security of the ideal portfolio, ideal allocation calculator 1260 or controller 1120 may calculate a holding quantity of the security, for example, by dividing by the last traded price of the security the total valuation multiplied by the ideal ratio assigned to the security. Ideal allocation calculator 1260 sends information indicating the ideal allocation to controller 1120.

Ideal allocation calculator 1260 further calculates an expectation of return and a risk value for each component security of the ideal portfolio, and sends information indicating the calculated expectation of return and the risk value to effective frontier generator 1270 and return histogram generator 1280.

Ideal allocation calculator 1260 may receive information indicating a specified expectation of return and/or a specified risk value for each component security of the ideal portfolio from controller 1120, and calculate a modified expectation of return of a portfolio as an expectation of return thereof and a modified risk value of a portfolio as an risk value thereof, using the specified expectations of return and/or risk values and a reconstructed variance-covariance matrix which is described below. When the received information does not include information indicating a specified expectation of return and/or a specified risk value for a component security, an actual expectation of return and/or an actual risk value of the security may be used alternatively as a specified expectation of return and/or a specified risk value of the security. Ideal allocation calculator 1260 may subsequently send information indicating the modified expectation of return and the modified risk value to controller 1120 and/or effective frontier generator 1270.

For example, for a pair of integers (i, j) satisfying 1≤i≤M, 1≤j≤M, correlation coefficient (or simply referred to as correlation) between securities i and j is calculated by:

$${r}_{i , j} = \frac{{s}_{i , j}}{\sqrt{{s}_{i , i}} \sqrt{{s}_{j , j}}} ,$$

where values s_{i,j}, and s_{i,j} are the (i, j)-element, (i, i)-element, and (j, j)-element of variance-covariance matrix Σ as described above, respectively. An M×M matrix having (i, j)-elements: {r_{i,j}} is referred to as a correlation matrix. Correlation coefficients are another example of values indicating joint variability. For example, let \hat{σ}ᵢ be a specified risk value of component security i. Then, reconstructed variance-covariance matrix \hat{Σ} is defined to be an M×M matrix having (i, j)-elements:

ŝ_{i,j}=\hat{σ}ᵢr_{i,j}\hat{σ}ⱼ.

The elements of reconstructed variance-covariance matrix \hat{Σ} are another example of values indicating joint variability. For a combination of ratios: (w₁, w₂, . . . , w_{M}) corresponding to a combination of component securities 1, 2, . . . , M of a portfolio P, modified risk value \hat{σ}_{P} of portfolio P may be calculated using reconstructed variance-covariance matrix \hat{Σ} by:

\hat{σ}_{P}=\sqrt{w^{T}\hat{Σ}w}.

Here, weight vector w is defined by w=(w₁, w₂, . . . w_{M})^{T}, as described above. Further, for example, let \hat{μ}ᵢ be a specified expectation of return of component security i. Then, modified expectation of return \hat{μ}_{P} of portfolio P may be calculated by:

$${\hat{μ}}_{P} = {{\sum }_{i = 1}}^{M} {w}_{i} {\hat{μ}}_{i} .$$

As such, for each random allocation described above, ideal allocation calculator 1260 can calculate a modified expectation of return and a modified risk value using (i) the specified expectation of return of securities indicated in the received information, (ii) the specified risk value of securities indicated in the received information, (iii) respective actual expectations of return of securities for which a specified expectation of return is not indicated in the received information, (iv) respective actual risk values of securities for which a specified risk value is not indicated in the received information, and (v) the correlation coefficients.

Effective frontier generator 1270 generates image data of an effective frontier chart. An effective frontier (also referred to as an efficient frontier, or efficiency frontier) is a set of portfolios which satisfy the condition that no other portfolio exists with a higher expectation of return but with the same risk value of return. Effective frontier generator 1270 receives from ideal allocation calculator 1260 information indicating an expectation of return and a risk value calculated for each of the random allocations, and plot in a chart points having a coordinate defined by the expectation of return and the risk value for the respective random allocations. In this chart, an effective frontier is visualized as a convex hull of the points, thus the chart is referred to as an effective frontier chart. Further, effective frontier generator 1270 may receive from ideal allocation calculator 1260 information indicating an expectation of return and a risk value calculated for each component security of the ideal portfolio, and may plot in the chart a point having a coordinate defined by the expectation of return and the risk value for each component security of the ideal portfolio. Further, effective frontier generator 1270 may receive from ideal allocation calculator 1260 information indicating an expectation of return and a risk value corresponding to the ideal portfolio, and may plot in the chart a point having a coordinate defined by the expectation of return and the risk value for the ideal portfolio. Effective frontier generator 1270 sends the image data to controller 1120.

Return histogram generator 1280 calculates an expected return distribution. In one example, return histogram generator 1280 receives from ideal allocation calculator 1260 information indicating an ideal allocation and information expectations of return and risk values for component securities of an ideal portfolio. Return histogram generator 1280 subsequently calculates an expected return distribution using the received information for a predetermined duration. The predetermined duration may be, for example, 1, 3, or 5 years. Return histogram generator 1280 subsequently generates image data of an expected return histogram using the calculated expected return distribution. Return histogram generator 1280 subsequently sends the image data of the expected return histogram to controller 1120.

Processor 1292 may include, for example, at least one of a CPU, a GPU, an ASIC, and an FPGA. Memory 1294 is connected to processor 1292, and stores data or information received from processor 1292, and sends the stored data or information to processor 1292. Memory 1294 may include, for example, may include, for example, at least one of a volatile memory device such as a DRAM device, an SRAM device, and a non-volatile memory device such as a ROM device, a flash memory device, a hard disk drive, a magnetic tape device, an optical memory device, an MRAM device, an ReRAM device, a PCM device. A program stored in memory 1294 may be read and executed by processor 1292 to realize the functions of login information manager 1210, portfolio information manager 1220, security information manager 1230, security evaluator 1250, ideal allocation calculator 1260, effective frontier generator 1270, and return histogram generator 1280.

<Example of Operation Flow>

FIG. 2 shows an operation flow diagram of systems, methods and programs for supporting portfolio construction according to an exemplary embodiment of the present application. The description provided below takes a tablet device as example client 1100 and an application (app) installed in the tablet device as an example program.

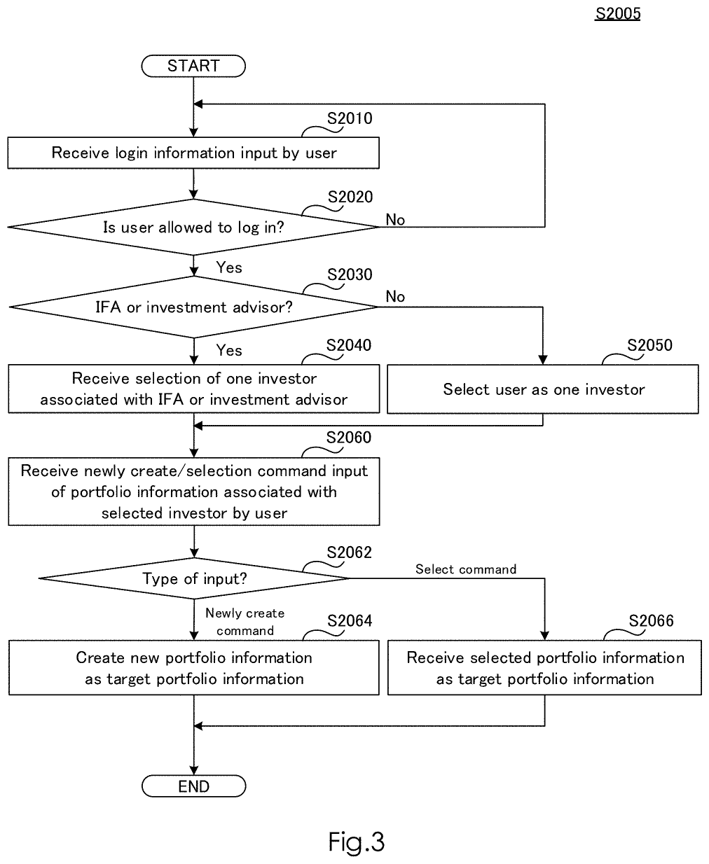

In step S2005, controller 1120 executes a login process and a provisioning process of target portfolio information, which is information indicating a portfolio which is subject to construction, reconstruction, or allocation. The details of a process executed in step S2005 are described below with reference to FIG. 3.

In step S2070, controller 1120 receives profile information from security information manager 1230 for each of a plurality of securities that are candidates for addition to a portfolio. Controller 1120 may store the received profile information in memory 1130.

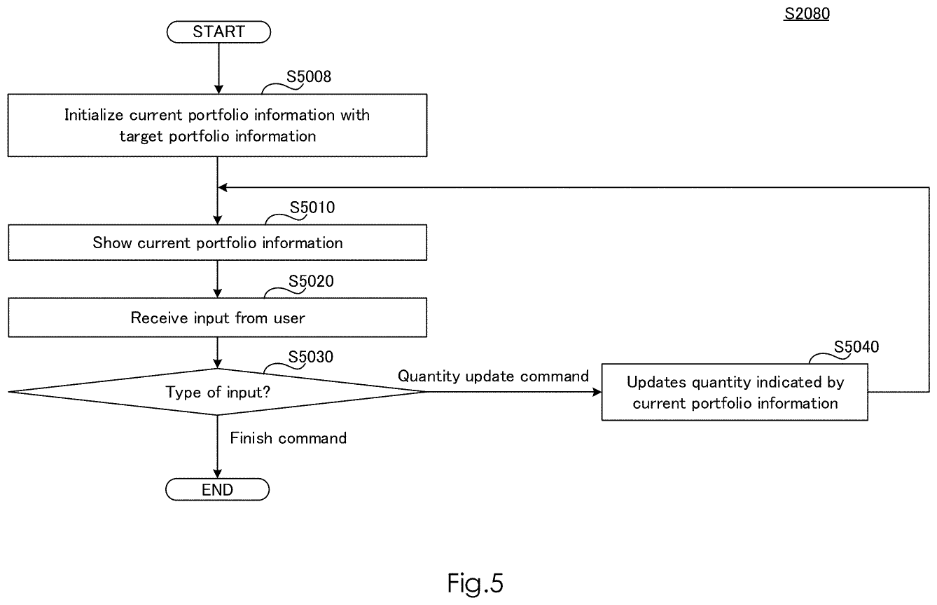

In step S2080, controller 1120 executes an edit process of current portfolio information. For example, in step S2080 of FIG. 2, the target portfolio information provisioned in step S2005 may be edited to be consistent with the current portfolio that is currently held by an investor. The details of the process executed in step S2080 are described below with reference to FIG. 5.

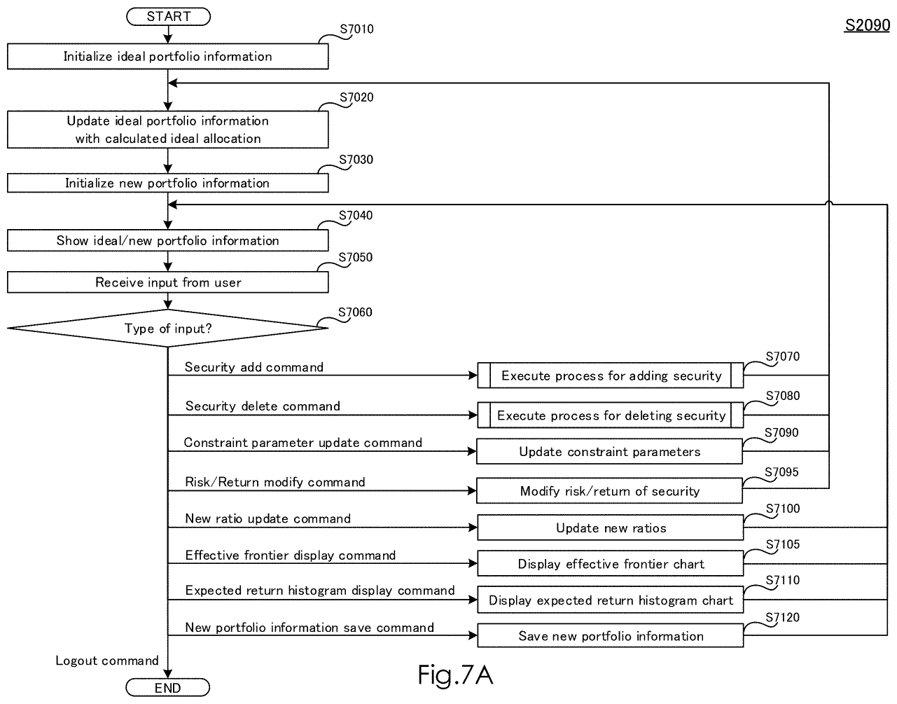

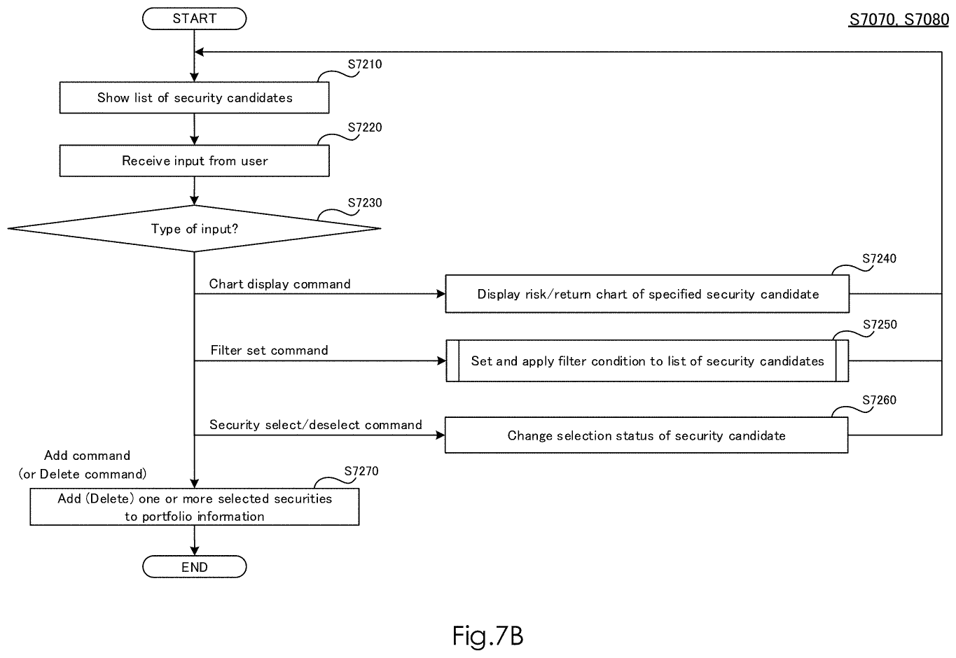

In step S2090, controller 1120 executes an edit process of new portfolio information. New portfolio information is information indicating a portfolio which may be newly held by the investor after reallocating the current portfolio. The details of the process executed in step S2090 are described below with reference to FIG. 7A. After step S2090, the process exits the flow diagram.

<User Login>

FIG. 3 shows an example of an operation flow diagram executed by controller 1120 of client 1100 in step S2005 of FIG. 2.

In step S2010, controller 1120 receives login information input by a user on display and input device 1110.

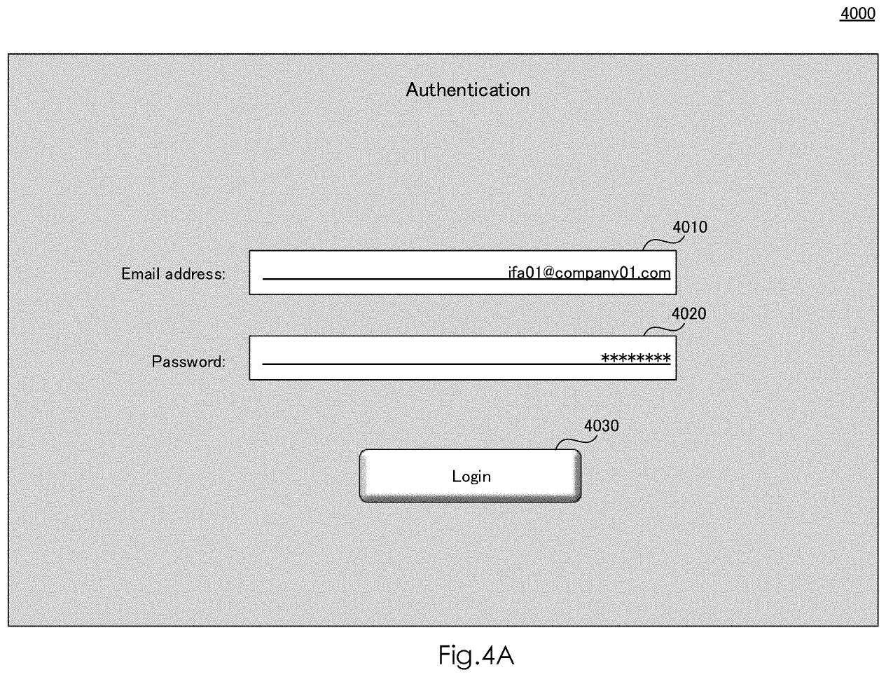

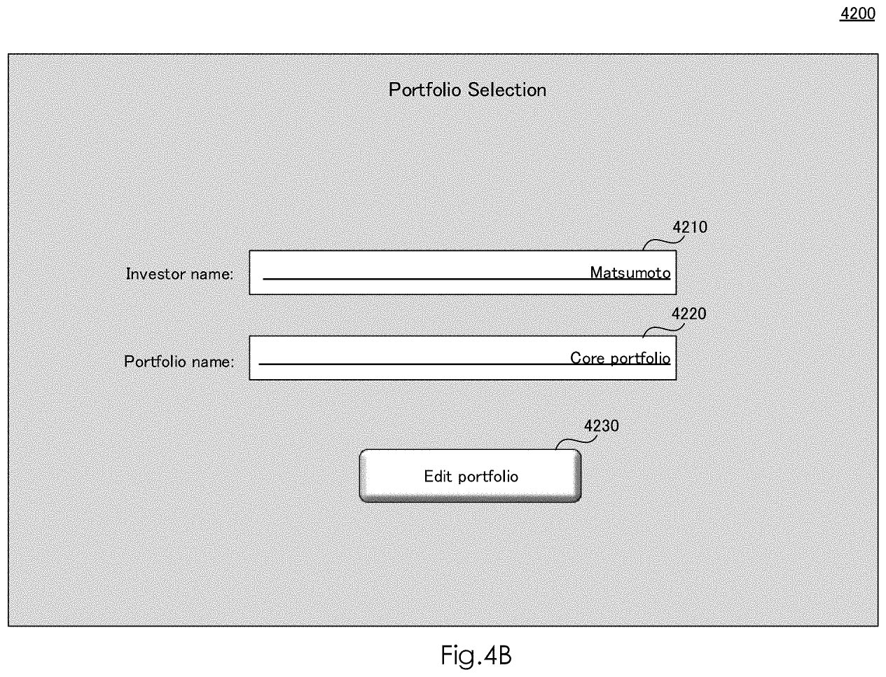

FIG. 4A shows an example of a screen image displayed by controller 1120 on display and input device 1110 in step S2010 of FIG. 3. In one example embodiment, screen 4000 includes an email address input field 4010 for inputting an email address and a password input field 4020 for inputting a password. In one example embodiment, a user is prompted on screen 4000 to input the user's email address and password, which are login information.

Referring back to FIG. 3, in step S2020, controller 1120 determines whether the user's login should be allowed or not. In one example, controller 1120 sends the login information to login information manager 1210 of server 1200. Login information manager 1210 receives the login information from controller 1120 and checks whether the received login information matches any of the information stored in login information manager 1210 and sends a check result to controller 1120. Controller 1120 receives the check result from login information manager 1210. When the check result indicates that the received login information matches login information for one of all users who are allowed to log in to system 1000, controller 1120 determines that the user is allowed to log in. Otherwise, controller 1120 determines that the user is not allowed to log in. When it is determined that the user is not allowed to log in, controller 1120 may prompt the user to enter login information again in step S2010.

In step S2030, controller 1120 determines whether the user is an IFA or an investment advisor. In one example embodiment, the check result received by controller 1120 in step S2020 includes information indicating whether the user is an IFA or an investment advisor, and controller 1120 determines whether the user is an IFA or an investment advisor based on the check result.

When the user is an IFA or investment advisor (step S2030: Yes), the process proceeds to step S2040. In step S2040, controller 1120 receives from display and input device 1110 investor selection information, which is information indicating a selection of one investor from one or more investors associated with the IFA or investment advisor. The process then proceeds to step S2060. When the user is not an IFA or investment adviser (step S2030: No), the process proceeds to step S2050. In step S2050, controller 1120 selects the user as one investor. The process then proceeds to step S2060.

In step S2060, controller 1120 sends investor identification information identifying the selected one investor to portfolio information manager 1220 and receives portfolio identifier list information associated with the investor identification information from portfolio information manager 1220. Controller 1120 subsequently shows the names of the portfolios contained in the portfolio identifiers indicated in the portfolio identifier list information to a user. Controller 1120 receives from display and input device 1110 a newly create command input for creating new portfolio information, or a select command input for selecting portfolio information associated with the selected one investor. When existing portfolio information is selected, the portfolio information to be constructed (hereinafter referred to as target portfolio information) is the selected existing portfolio information.

FIG. 4B shows an example of a screen image displayed by controller 1120 on display and input device 1110 in steps S2040 and S2060 of FIG. 3. In one example embodiment, screen 4200 includes investor selection combo box 4210 for inputting a selection of one investor from one or more investors and portfolio information selection combo box 4220 for inputting a portfolio information selection input or a newly create command associated with the selected investor. Portfolio information selection combo box 4220 may show the names of the portfolios contained in the portfolio identifiers.

In step S2062, controller 1120 determines the type of input received from display and input device 1110 in step S2060. When the type of input is a newly create command input, the process proceeds to step S2064. In step S2064, controller 1120 provisions newly created portfolio information as target portfolio information. In one example embodiment, the newly created portfolio information is portfolio information indicating an empty portfolio such as one shown in Table 4 provided below. After step S2064, the process exits the flow diagram.

TABLE 4
Newly created portfolio information example

| | Component currency/security | Holding quantity |
|---|---|---|
| Component asset 1 | Japanese yen | JPY 0 |
| Component asset 2 | US dollar | USD 0.00 |

In step S2062, when the type of input is a select command input, the process proceeds to step S2066. In step S2066, controller 1120 sends information indicating a portfolio identifier corresponding to the portfolio information selection input, and receives the portfolio information identified by the portfolio identifier from portfolio information manager 1220, and provisions the received portfolio information as target portfolio information. After step S2066, the process exits the flow diagram.

FIG. 5 shows an example of an operation flow diagram executed by controller 1120 of client 1100 in step S2080 of FIG. 2. In step S5008, controller 1120 initializes the current portfolio information with the target portfolio information provisioned in step S2005 of FIG. 2. For example, an initialization of portfolio information herein may be done by a copy or a duplication of portfolio information. Controller 1120 may store the current portfolio information in memory 1130.

<Current Portfolio Setup>

In step S5010, controller 1120 displays the current portfolio information on display and input device 1110.

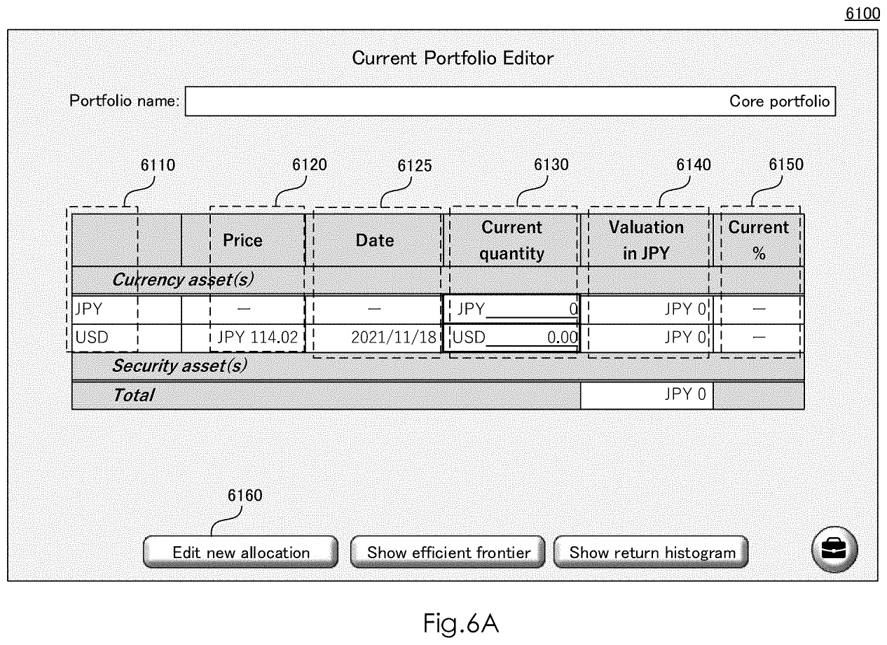

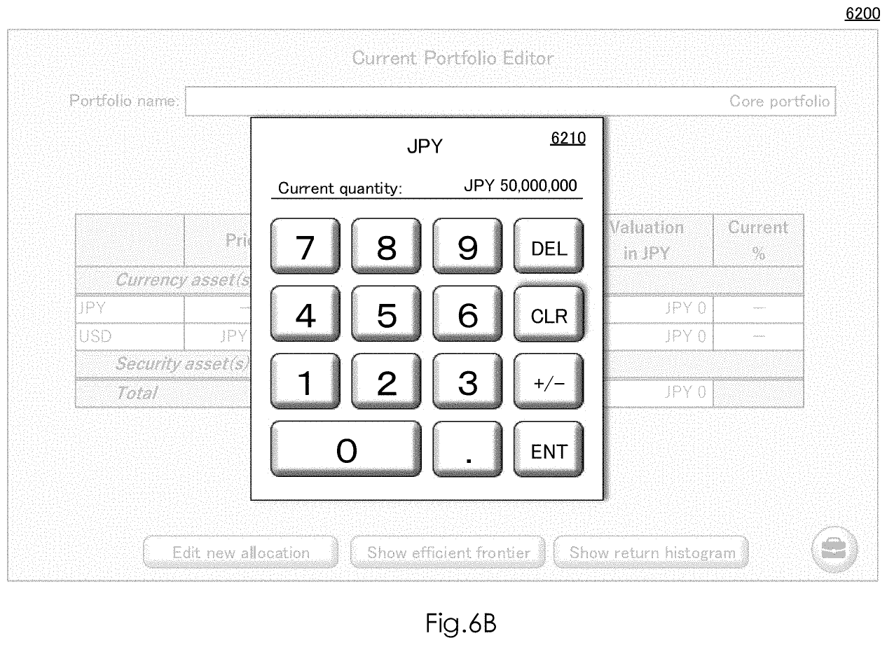

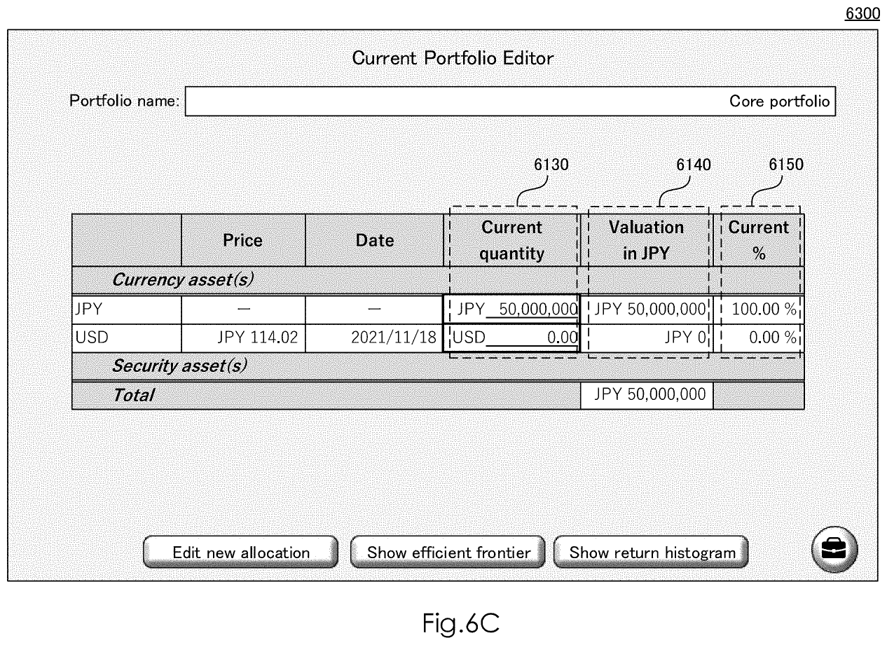

FIG. 6A shows an example of a screen image displayed on display and input device 1110 by controller 1120 in step S5010 of FIG. 5. In one example embodiment, screen 6100 includes name fields 6110 showing currency/security names, last traded price fields 6120 showing the last traded prices, last traded date fields 6125 showing the last traded dates, current holding quantity fields 6130 showing current holding quantities, reference-currency-equivalent valuation fields 6140 showing reference-currency-equivalent valuations of the component assets allocated according to current holding quantities, and current ratio fields 6150 indicating current holding ratios (hereinafter referred to as current ratios) of reference-currency-equivalent valuations. The last traded prices may be market close prices at the respective last traded dates. Each name field 6110, each last traded price field 6120, each current holding quantity field 6130, each reference-currency-equivalent valuation field 6140, and each current ratio field 6150 that are aligned in a row correspond to one component asset included in the current portfolio information. In one example embodiment, current holding quantity fields 6130 are user-editable only for the currency assets, as shown in FIG. 6A. In another example embodiment, current holding quantity fields 6130 are user-editable for both the currency assets and the security assets.

Screen 6100 is an example of a screen that is shown when a portfolio is newly created in step S2064 of FIG. 3, i.e., when the portfolio contains only (empty) currency assets as shown in <Table 4> provided above. When the portfolio indicated by the portfolio information that was received in step S2066 of FIG. 3 contains other currency and/or security component assets, information thereof may be shown on screen 6100, as well.

Referring back to FIG. 5, in step S5020, controller 1120 receives an input from display and input device 1110. The types of input may include, for example, a quantity update command input of a target component currency or security for updating the quantity indicated by the current portfolio information, or a finish command input for finishing edit of the current portfolio information. For example, a reception of the quantity update command input of a component security or currency may be through a detection by controller 1120 of a tap or click on current holding quantity field 6130 for the target component currency or security. For example, a reception of the finish command input may be through a detection by controller 1120 of a tap or click on edit new allocation button 6160.

In step S5030, controller 1120 determines the type of input received in step S5020. When the type of the received input is a quantity update command input for a target component currency or security, the process proceeds to step S5040. In step S5040, controller 1120 receives a value update input for a quantity of the target component currency or security, and updates the quantity indicated by the current portfolio information with the value indicated by the value update input. The process subsequently returns to step S5010.

FIG. 6B shows an example of a screen image displayed by controller 1120 on display and input device 1110 in step S5040 of FIG. 5. Screen 6200 includes holding quantity input pad 6210 for inputting a quantity of a target component currency or security. In this example, the target component currency or security is Japanese yen. Holding quantity input pad 6210 has a calculator-like interface equipped with numeric button widgets used to input numeric digits representing a quantity of the target component currency or security to be newly invested or to be added to the current portfolio. A value that is inputted via holding quantity input pad 6210 may be used as a value update input in user-editable current holding quantity field 6130 for the target component currency or security. Although holding quantity input pad 6210 is used here as an input method, any input method may be used to receive a value input by a user.

FIG. 6C shows an example of a screen image displayed by controller 1120 on display and input device 1110 in step S5010 of FIG. 5 after step S5040. On screen 6300, current holding quantity fields 6130, reference-currency-equivalent valuation fields 6140, and current ratio fields 6150 have been respectively updated to be consistent with the currency holding quantity of 50 million yen that has been inputted via holding quantity input pad 6210 in FIG. 6B. More specifically, the value of current holding quantity field 6130 for the target component currency or security is updated with a holding quantity that was inputted via holding quantity input pad 6210, and reference-currency-equivalent valuation field 6140 for the target component currency or security is updated with a value calculated by multiplying a price per unit of the target component currency or security by the holding quantity. Reference-currency-equivalent valuation fields 6140 are updated with a value calculated by dividing a value in reference-currency-equivalent valuation field 6140 by the sum of values in reference-currency-equivalent valuation fields 6140 for the component assets.

Referring back to FIG. 5, when the type of the input received by controller 1120 in step S5030 is a finish command input, the process exits the operation flow.

FIG. 7A shows an example of an operation flow diagram executed by controller 1120 of client 1100 in step S2090 of FIG. 2. FIG. 7B shows an example of an operation flow diagram executed by controller 1120 of client 1100 in steps S7070 and steps S7080 of FIG. 7A. Referring to FIG. 7A, in step S7010, controller 1120 initializes ideal portfolio information with the current portfolio information.

<Calculation of Expectation of Return and Risk Value of Portfolio>

In step S7020, controller 1120 sends information indicating a combination of securities included in the ideal portfolio and information indicating constraint parameters to ideal allocation calculator 1260. Controller 1120 subsequently receives from ideal allocation calculator 1260 information indicating an ideal allocation. Controller 1120 may update the ideal portfolio information with the information indicating an ideal allocation. Controller 1120 may store the updated ideal portfolio information in memory 1130.

In step S7030, controller 1120 initializes new portfolio information with the ideal portfolio information. Controller 1120 may store the new portfolio information in memory 1130. In one example embodiment, if the ideal allocation has not been calculated, controller 1120 may initialize new portfolio information with the current portfolio information.

In step S7040, controller 1120 shows the ideal portfolio information and the new portfolio information on display and input device 1110. For example, display and input device 1110 shows ideal ratios of the ideal allocation and/or newly holding ratios (hereinafter referred to as new ratios) of a new allocation indicated by the new portfolio information. The new ratios are ratios of the reference-currency-equivalent valuations of the component assets of the newly holding portfolio. Controller 1120 may show the ratios by showing numerical values indicating the ratios or by showing a pie chart indicating the ratios on display and input device 1110.

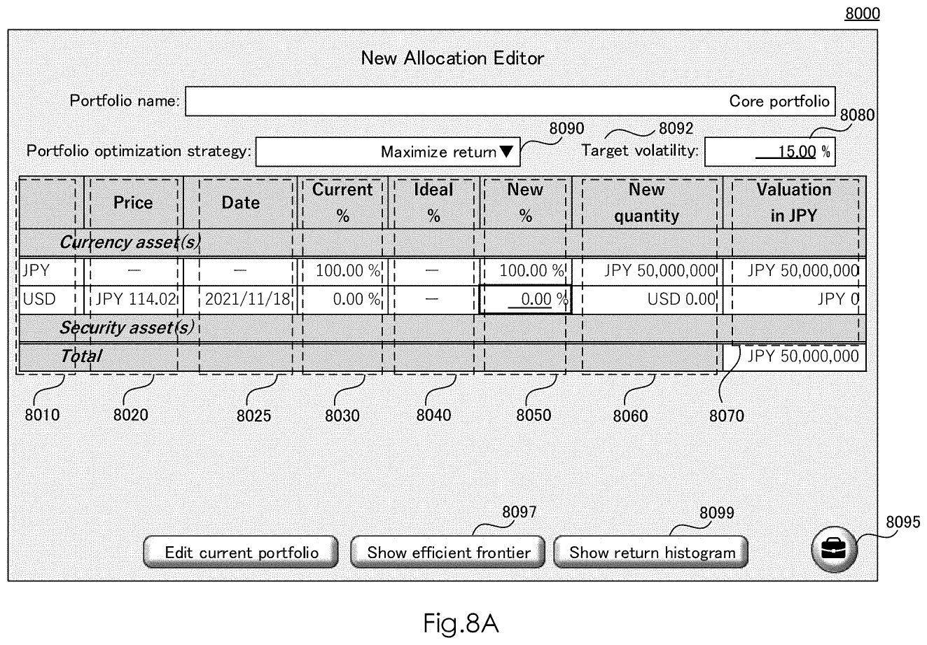

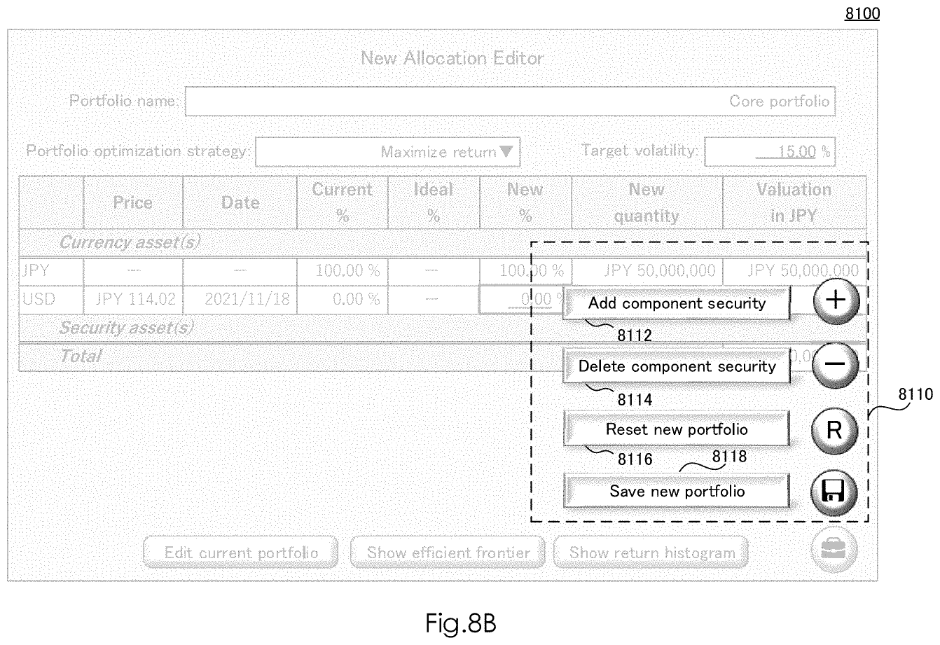

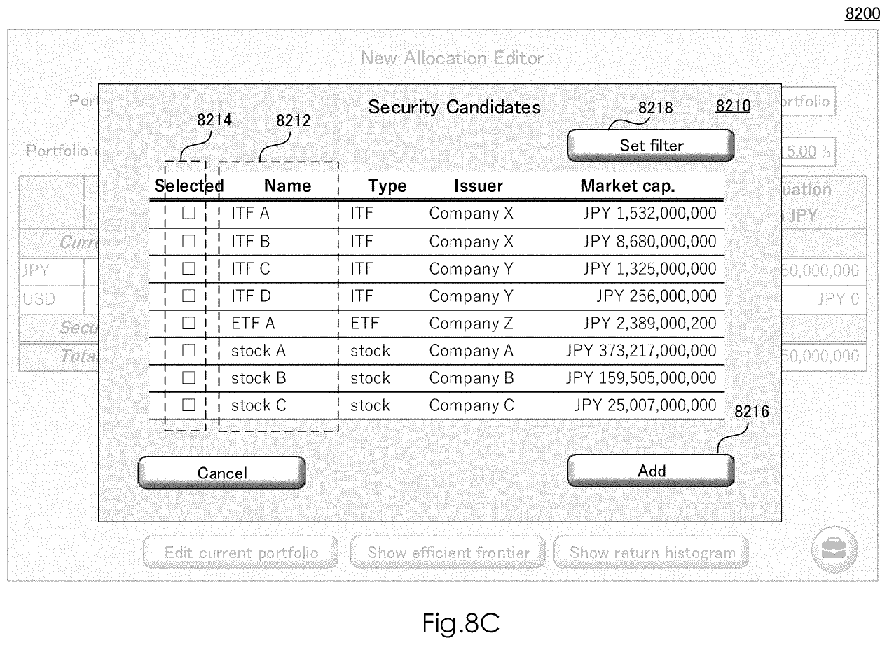

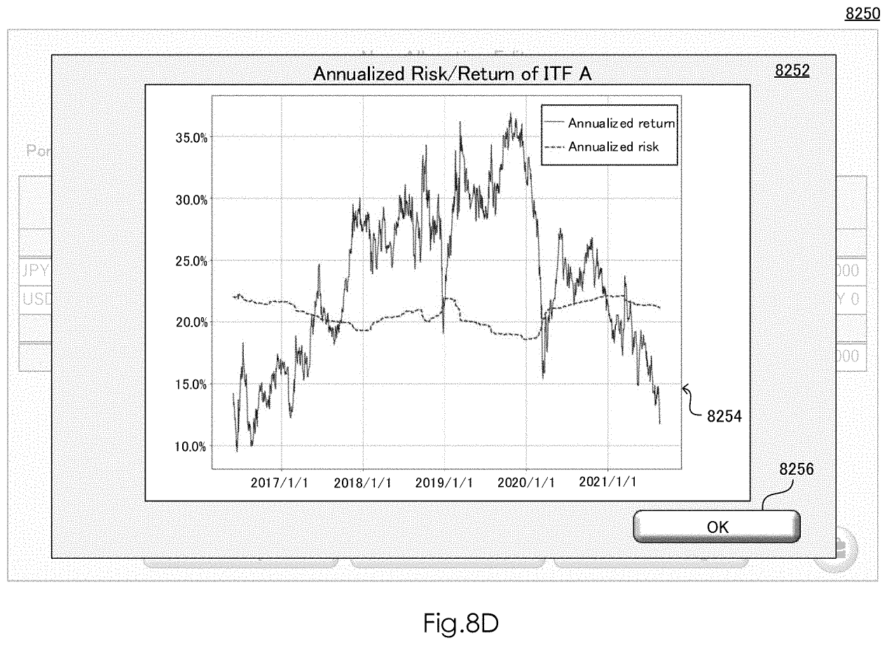

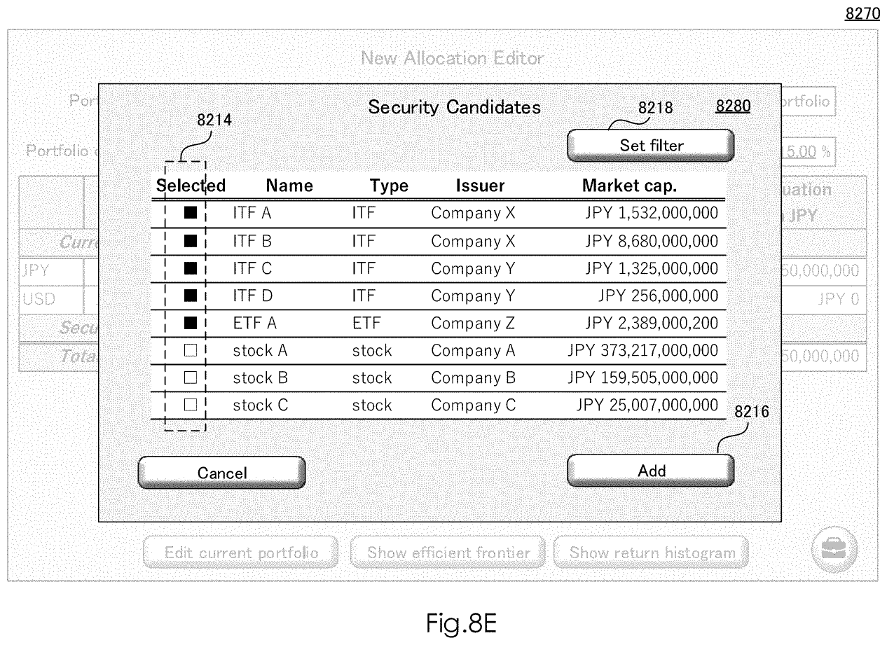

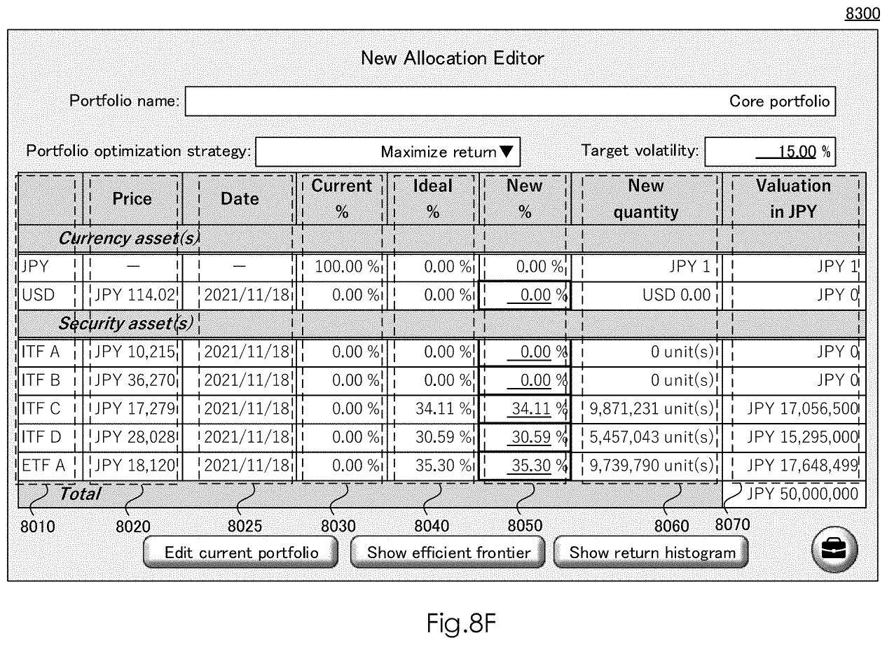

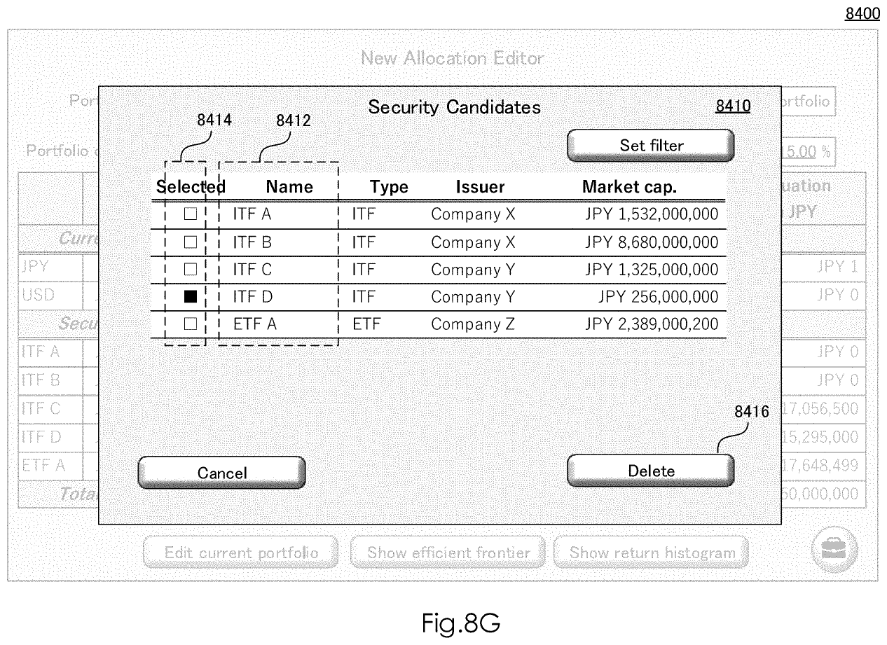

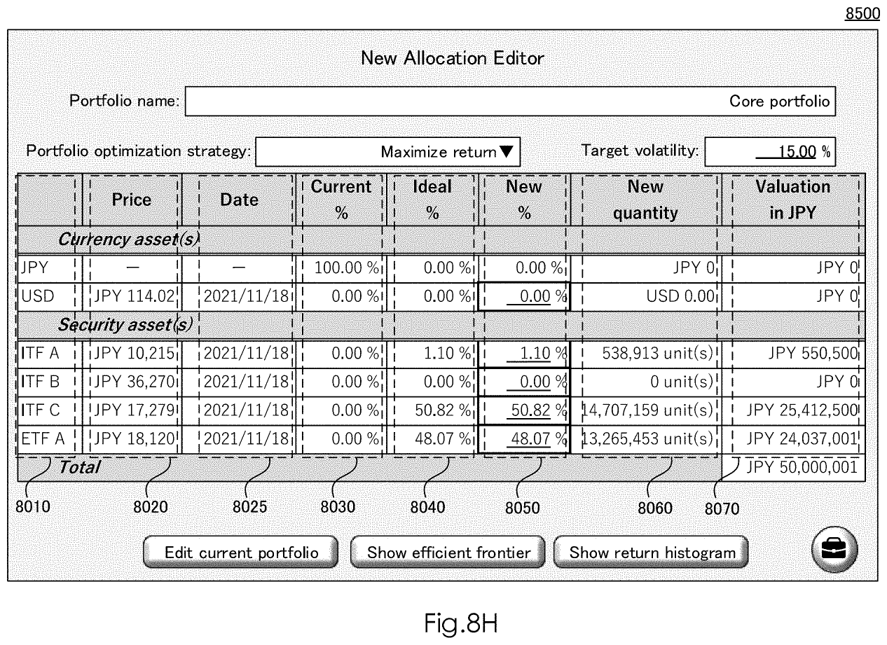

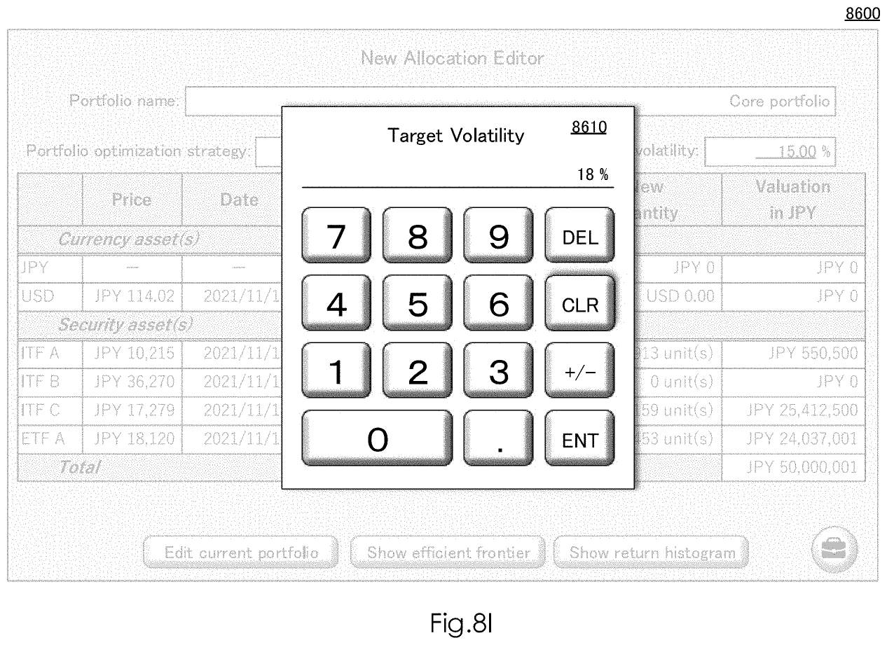

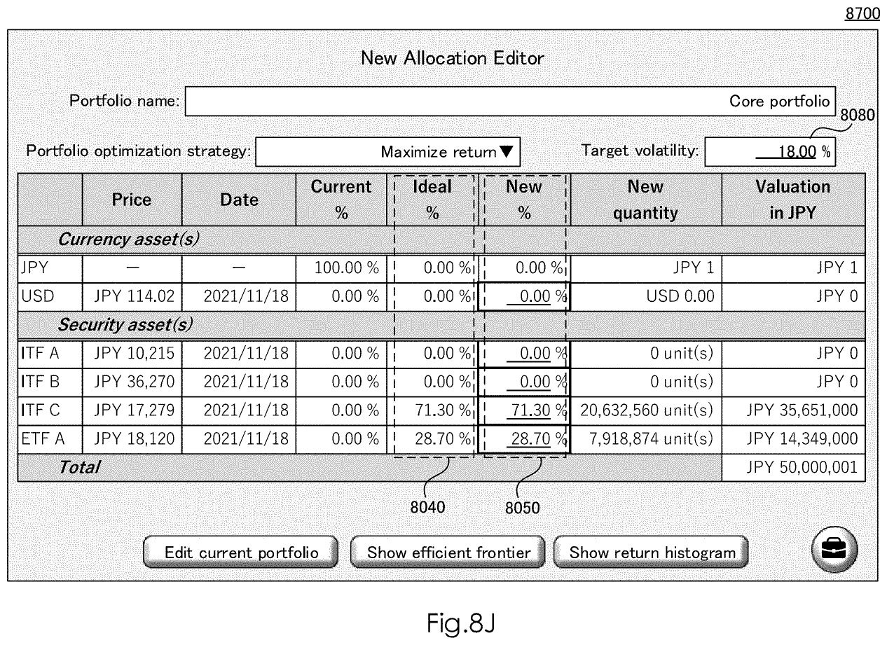

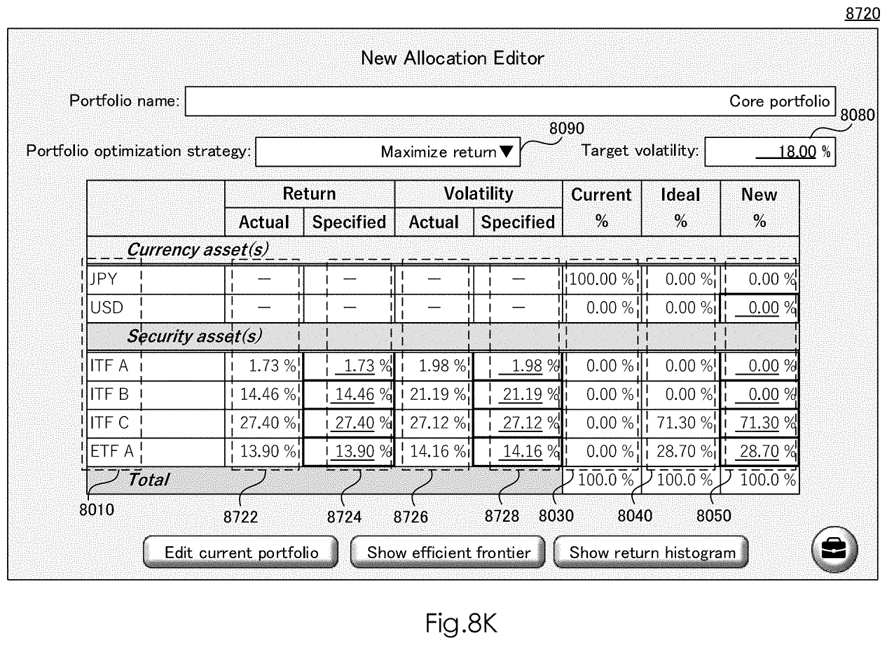

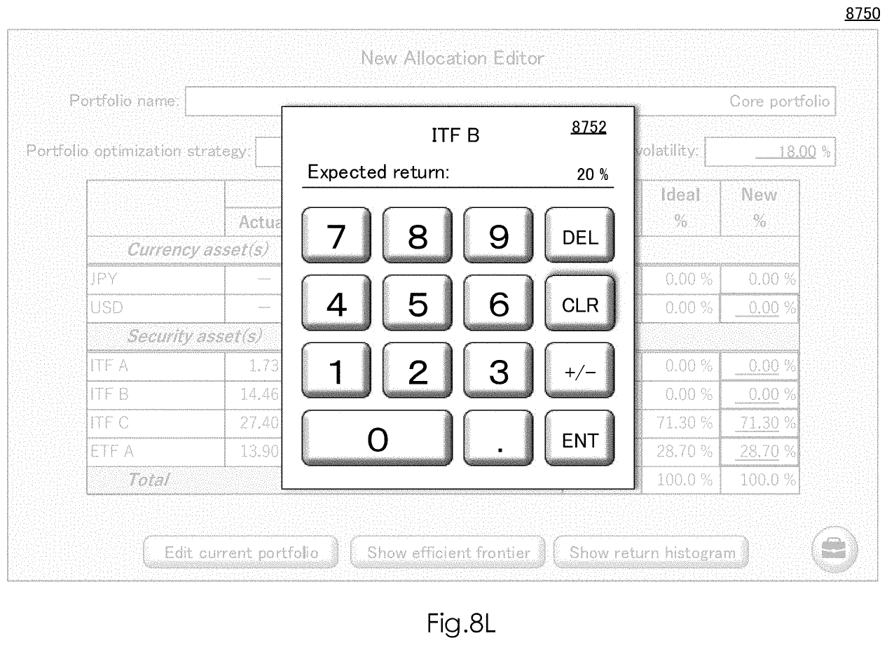

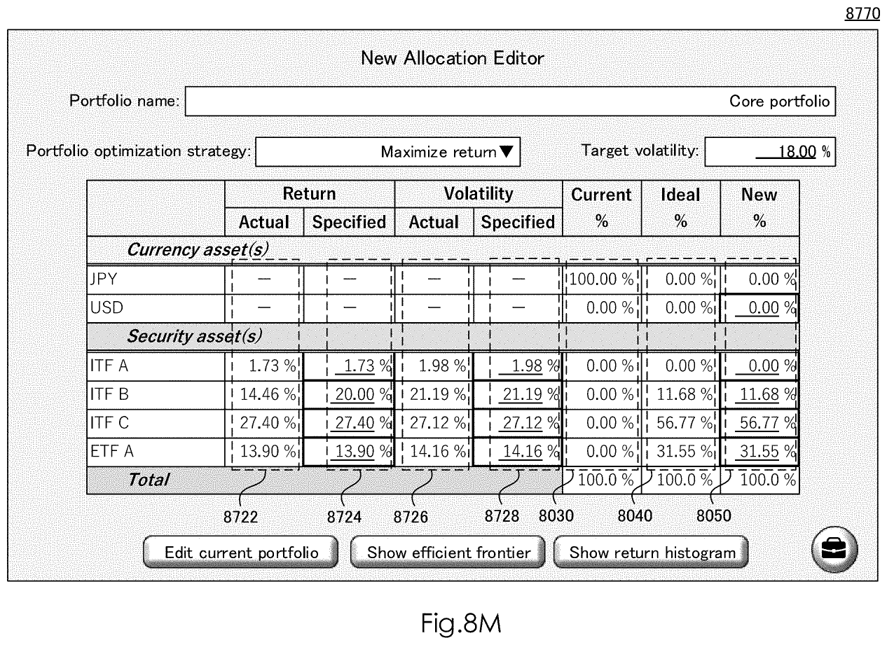

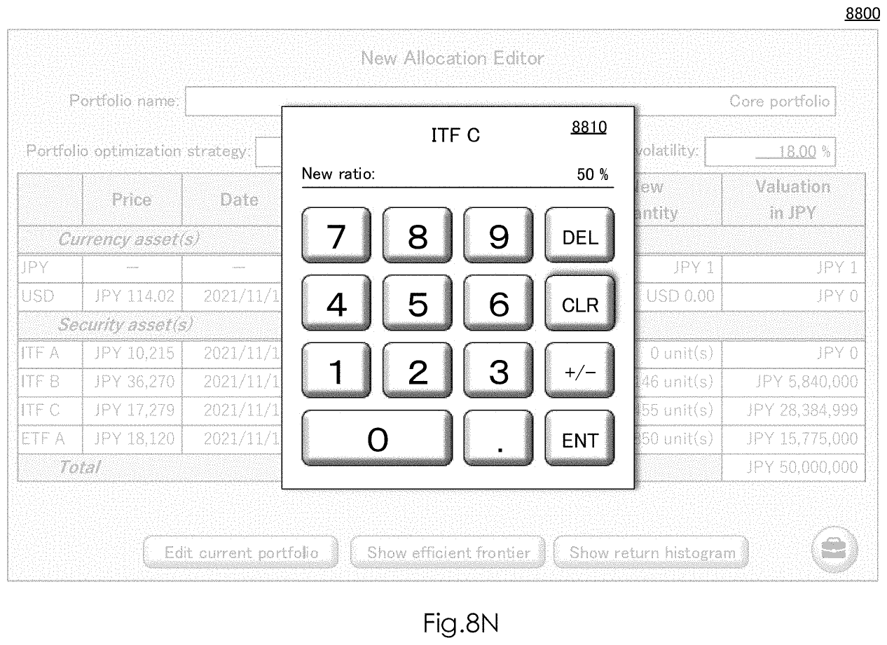

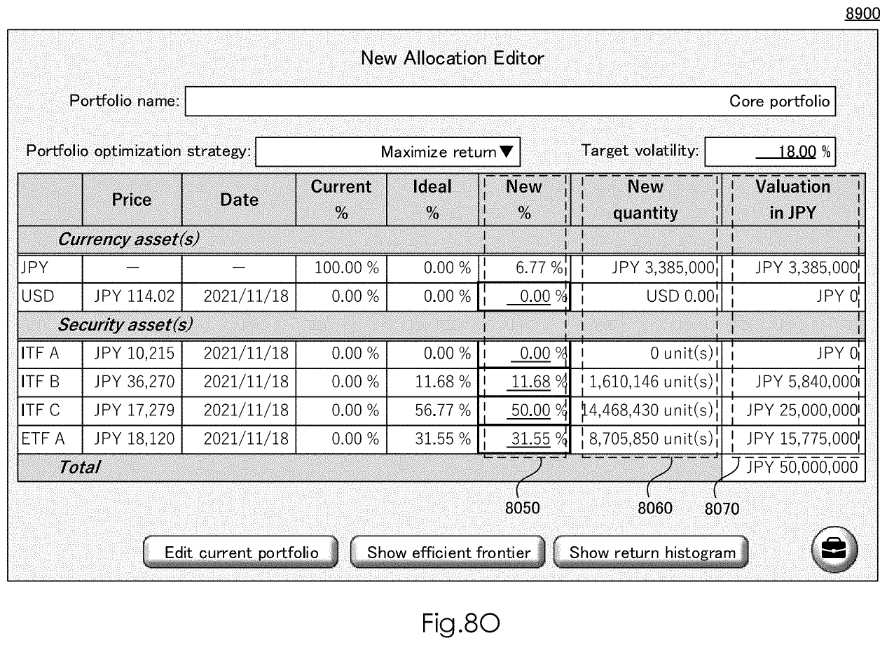

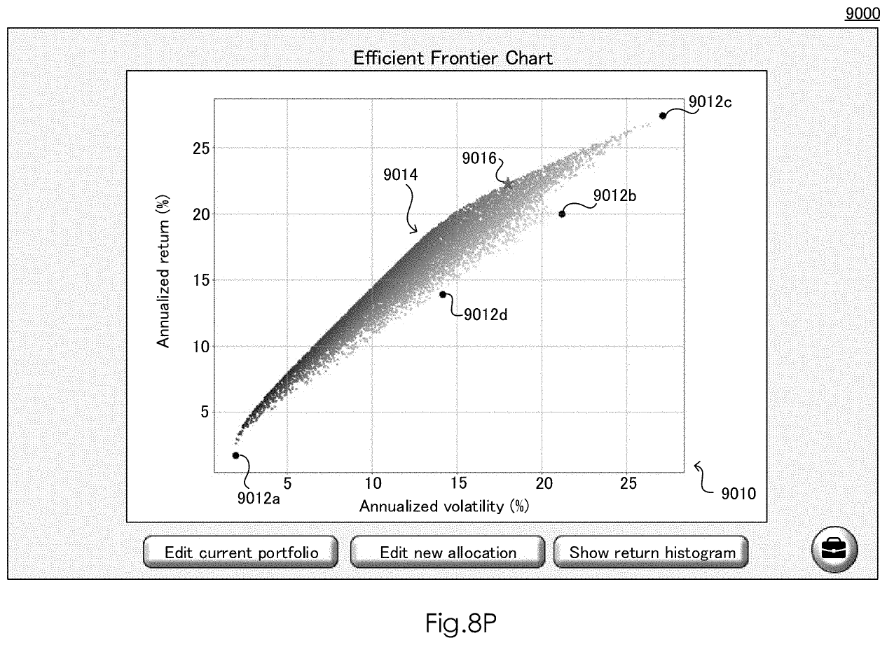

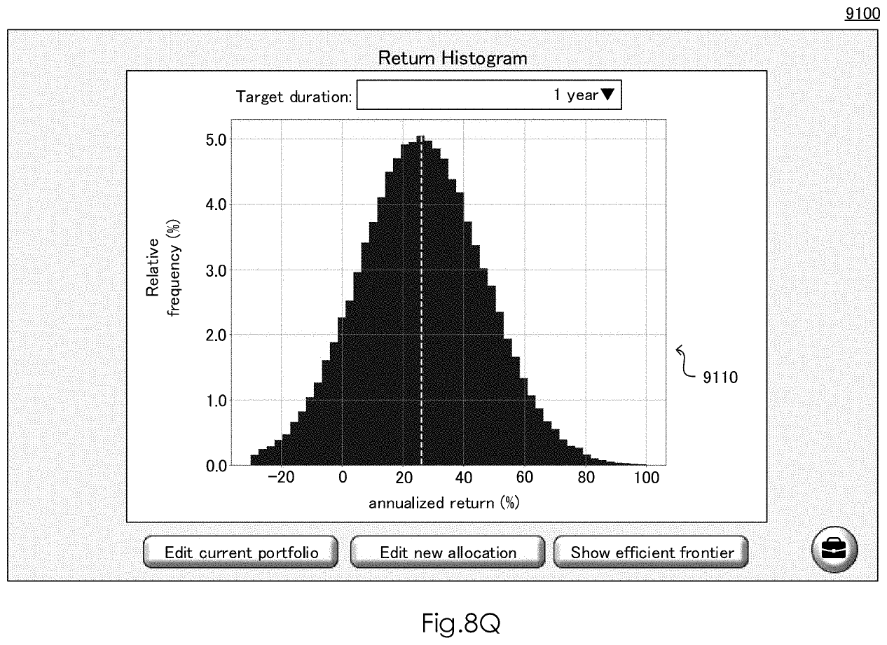

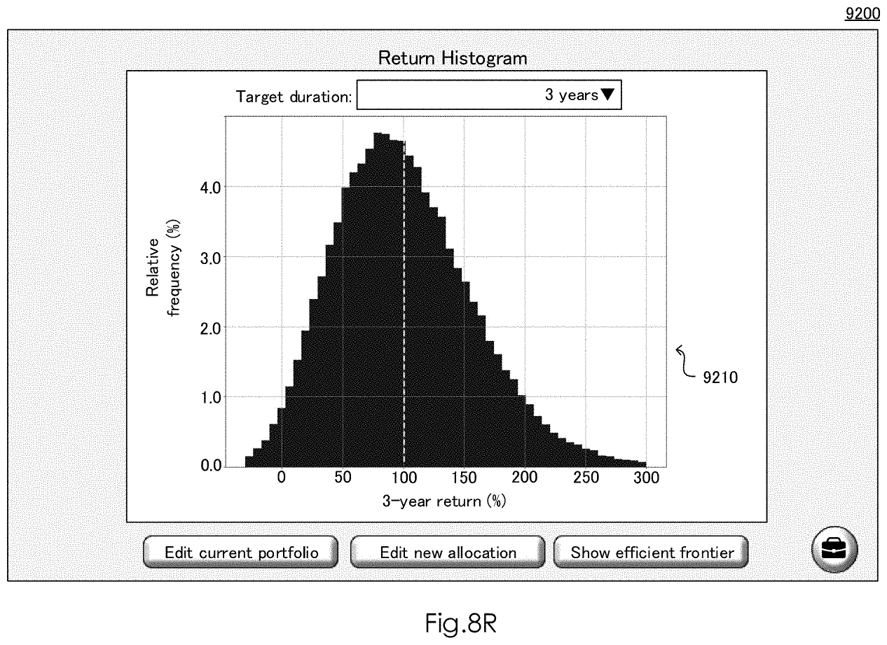

FIG. 8A shows an example of a screen image displayed on display and input device 1110 by controller 1120 in step S7040 of FIG. 7A. In one example embodiment, screen 8000 includes name fields 8010 showing currency/security names, last traded price fields 8020 including the last traded prices, last traded date fields 8025 showing the last traded dates, current ratio fields 8030 showing current ratios of reference-currency-equivalent valuations, ideal ratio fields 8040 showing ideal ratios of reference-currency-equivalent valuations, new ratio fields 8050 showing new ratios of reference-currency-equivalent valuations, newly holding quantity fields 8060 showing newly holding quantities, reference-currency-equivalent valuation fields 8070 showing a reference-currency-equivalent valuation of the component assets that are allocated according to the new ratios, constraint parameter input field 8080 for inputting one or more constraint parameters, strategy selection combo box 8090 for selecting a strategy for optimizing the portfolio, and strategy label 8092 for showing a label corresponding to the strategy selected in strategy selection combo box 8090. The last traded price (or close price) shown by last traded price fields 8020 is per unit quantity used for displaying a price. The unit quantity used for displaying a price may be any quantity, for example, conventionally used quantities, such as 10,000 units for ITFs or ETFs, or 1 share for a stock. In one example embodiment, the strategies selectable by a user in strategy selection combo box 8090 may be “Maximize return,” “Minimize risk value,” and “Maximize Sharpe ratio.” In one example, controller 1120 shows on strategy label 8092 “Target volatility,” “Target volatility,” and “Risk-free rate,” in response to a detection by controller 1120 of selection: “Maximize return,” “Minimize risk value,” and “Maximize Sharpe ratio,” respectively, in strategy selection combo box 8090.

Each name field 8010, each last traded price field 8020, each current ratio field 8030, each ideal ratio field 8040, each new ratio field 8050, each newly holding quantity field 8060, and each reference-currency-equivalent valuation field 8070 that are aligned in a row correspond to one component asset included in at least one of the current portfolio information, the ideal portfolio information, and the new portfolio information. In one example embodiment, ideal ratio fields 8040 are not user-editable. In another example embodiment, in new ratio fields 8050 and newly holding quantity fields 8060, only new ratio fields 8050 corresponding to the component assets other than a reference currency asset are user-editable, as shown in FIG. 8A. In yet another example embodiment, in new ratio fields 8050 and newly holding quantity fields 8060, only newly holding quantity fields 8060 corresponding to the component assets other than a reference currency asset are user-editable. In yet another example embodiment, in new ratio fields 8050 and newly holding quantity fields 8060, both new ratio fields 8050 and newly holding quantity fields 8060 corresponding to the component assets other than a reference currency asset are user-editable.

<Adjustment of Other Parameters>

In one example embodiment, an interface may be provided on screen 8000 for adjusting parameters other than the constraint parameters used in the portfolio risk and return calculation. An example of such parameters is the number of combinations of random allocations used in a simulation executed by ideal allocation calculator 1260 as described above.

Referring back to FIG. 7A, in step S7050, controller 1120 receives an input by a user from display and input device 1110. The types of input may include, for example, a security add command input for adding one or more component securities to the portfolios indicated by the current, ideal, and new portfolio information, a security delete command input for deleting one or more component securities from the portfolios indicated by the current, ideal, and new portfolio information, a constraint parameter update command input for updating constraint parameters, a new ratio update command input for updating a new ratio, an effective frontier display command input for displaying an effective frontier chart, an expected return histogram display command input for displaying an expected return distribution, a new portfolio information save command input for saving the edited new portfolio information, or a logout command input for letting a user to log out. For example, a reception of the constraint parameter update command input may be through a detection by controller 1120 of a tap or click on constraint parameter input field 8080, strategy selection combo box 8090, or strategy label 8092. For example, a reception of the new ratio update command input may be through a detection by controller 1120 of a tap or click on user-editable current holding quantity fields 6130. For example, a reception of the effective frontier display command input may be through a detection by controller 1120 of a tap or click on show effective frontier button 8097 of FIG. 8A. For example, a reception of the expected return histogram display command input may be through a detection by controller 1120 of a tap or click on show return histogram button 8099.

FIG. 8B shows a further example of a screen displayed by controller 1120 on display and input device 1110 in step S7050 of FIG. 7A. In one example embodiment, screen 8100 is displayed in response to a detection by controller 1120 of a click or tap on menu expand button 8095. Screen 8100 includes menu selection interface 8110 expanded above menu expand button 8095. Menu selection interface 8110 includes add component security button 8112, delete component security button 8114, reset new portfolio button 8116, and save new portfolio button 8118. For example, a reception of the security add command input may be through a detection by controller 1120 of a tap or click on add component security button 8112. For example, a reception of the security delete command input may be through a detection by controller 1120 of a tap or click on delete component security button 8114. For example, in response to a detection of a tap or click on reset new portfolio button 8116, controller 1110 copies the current or ideal portfolio information to the new portfolio information. For example, a reception of the save command input may be through a detection by controller 1120 of a tap or click on save new portfolio button 8118.

<Addition of Component Securities>

Referring back to FIG. 7A, in step S7060, controller 1120 determines the type of input received in step S7050. When the type of input received in step S7050 is a security add command input, the process proceeds to step S7070. In step S7070, controller 1120 executes a process for adding one or more component securities to the portfolios indicated by the current, ideal, and new portfolio information, for example, by adding empty component assets for the respective one or more component securities to the portfolios. Thus, the security add command input functions as a selection input indicating a selection of two or more securities to be added to the ideal portfolio from security candidates.

Referring to FIG. 7B, in step S7210, controller 1120 shows a list of security candidates for addition to a portfolio on display and input device 1110. The security candidates for addition to a portfolio may include, for example, 1,000 or more domestic ITFs and/or ETFs and/or domestic individual stocks and/or overseas individual stocks. In one example embodiment, controller 1120 may receive information indicating a ranking of the security candidates from security evaluator 1250 and sort the security candidates for addition to a portfolio based on the ranking.

FIG. 8C shows an example of a screen image displayed by controller 1120 on display and input device 1110 in step S7210 of FIG. 7A. In one example embodiment, screen 8200 includes security candidates dialog window 8210. Security candidates for addition to a portfolio are listed in security candidates dialog window 8210. For each security candidate for investment, security candidates dialog window 8210 may show name label 8212 showing a name of the security candidate and check box 8214 for showing whether the security candidate is currently selected by a user or not. In an example shown in security candidates dialog window 8210, security candidates: ITF A, ITF B, ITF C, ITF D, and ETF A are currently selected by a user. When screen 8200 is not large enough to show all the security candidates, the list of security candidates may be scrollable such that any security candidate in the list can be shown on screen 8200. Security candidates dialog window 8210 may further include add button 8216. In one example embodiment, security candidates dialog window 8210 may further show the ranking of the security candidates.

Referring to FIG. 7B, in step S7220, controller 1120 receives an input by a user from display and input device 1110. The types of input may include, for example, a chart display command input for displaying a risk/return chart of a specified security candidate, a filter set command input for setting and applying filter condition to the list of security candidates, a security select/deselect command input for changing a selection status of a security candidate, and an add command input for adding one or more selected security candidates to the current, ideal, and new portfolio information. For example, a reception of the chart display command input may be through a detection by controller 1120 of a tap or click on name label 8212. For example, a reception of the filter set command input may be through a detection by controller 1120 of a tap or click on set filter button 8218. For example, a reception of the security select/deselect command input may be through a detection by controller 1120 of a tap or click on check box 8214. The status of each check box 8214 may be switched between selected and deselected by controller 1120 in response to a detection of a tap or click on the check box 8214. For example, a reception of the add command input may be through a detection by controller 1120 of a tap or click on add button 8216.

In step S7230, controller 1120 determines the type of input received in step S7220. When the type of input received in step S7220 is a chart display command input, the process proceeds to step S7240. In step S7240, controller 1120 displays a risk/return chart of a specified security candidate on display and input device 1110.

FIG. 8D shows an example of a screen image displayed by controller 1120 on display and input device 1110 in step S7240 of FIG. 7B. In one example, screen 8250 includes risk/return chart dialog window 8252, which shows a moving average chart 8254 of time-series changes in the expectation of return and the risk value over a predetermined period of time for the target security candidate. The predetermined period may be, for example, the past 1 year, the past 3 years, or the past 5 years. Referring to a chart for the target security candidate shown in screen 8250, a user may decide whether or not to select the target security candidate to be added to the new portfolio. In response to a detection by controller 1120 of tap of click on OK button 8256, the process returns to S7210 of FIG. 7B.

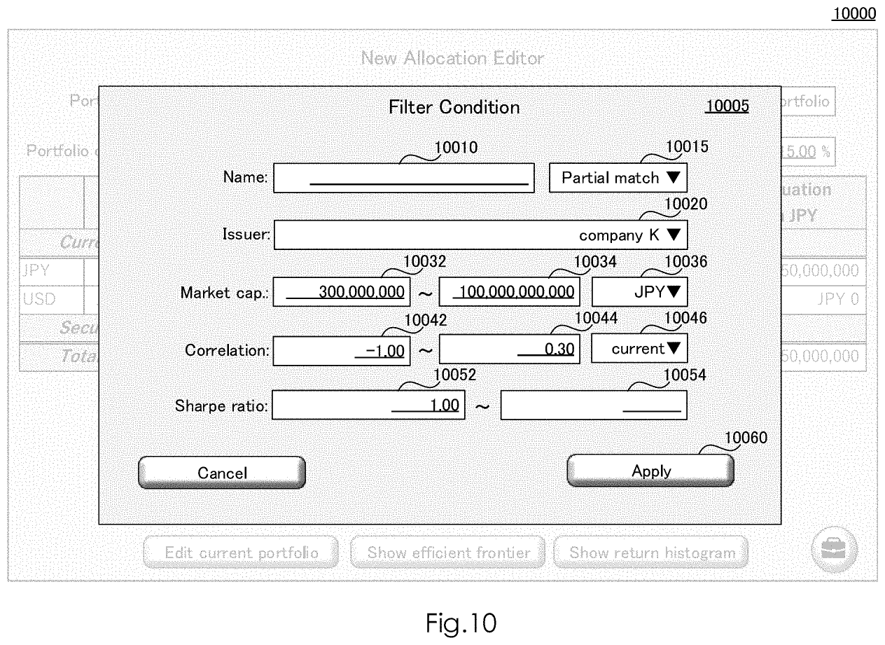

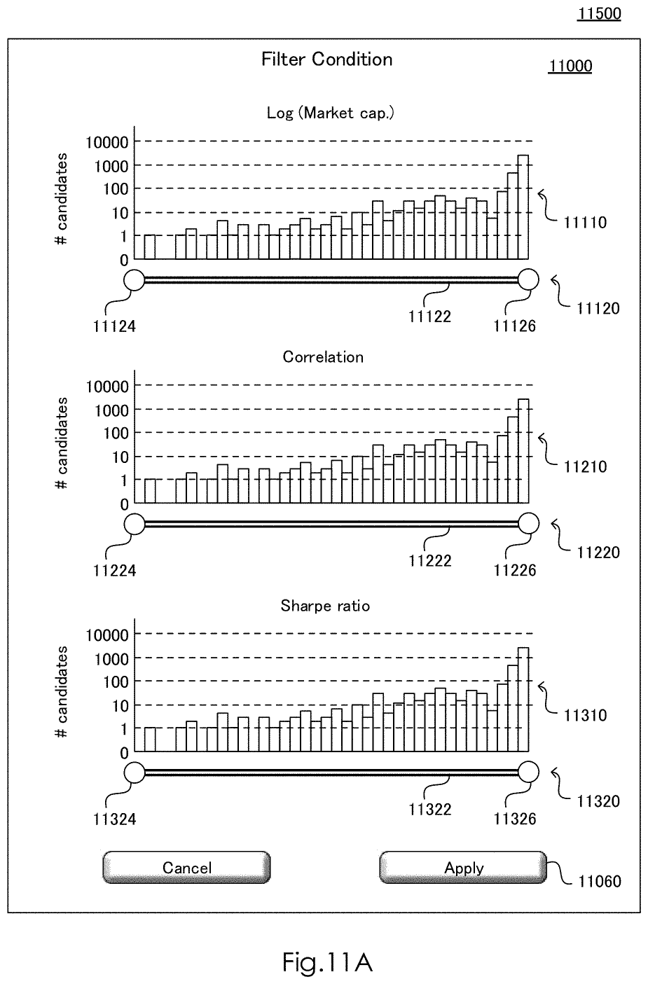

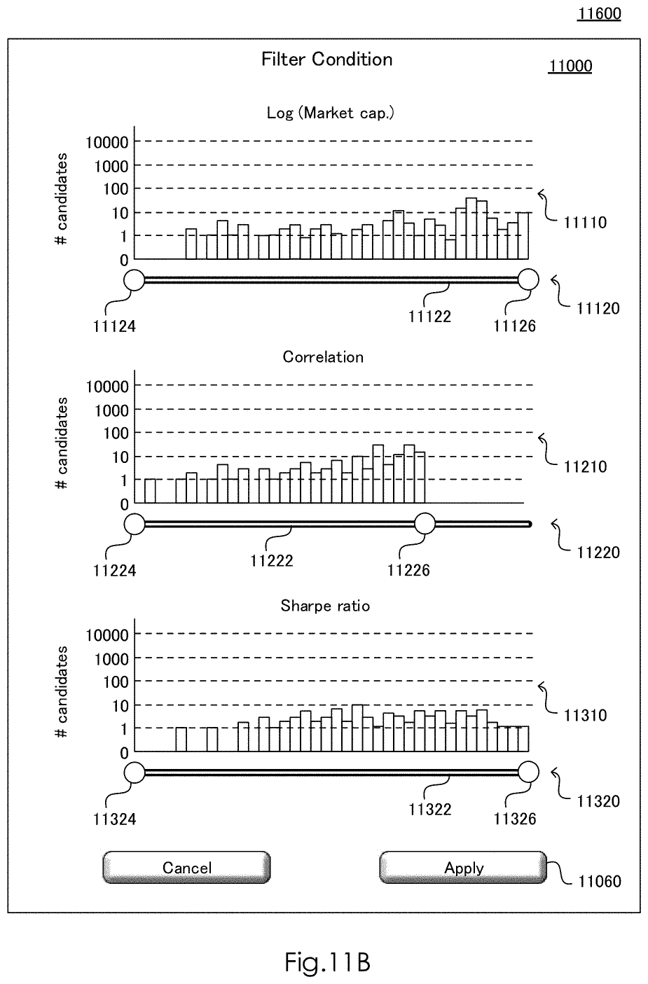

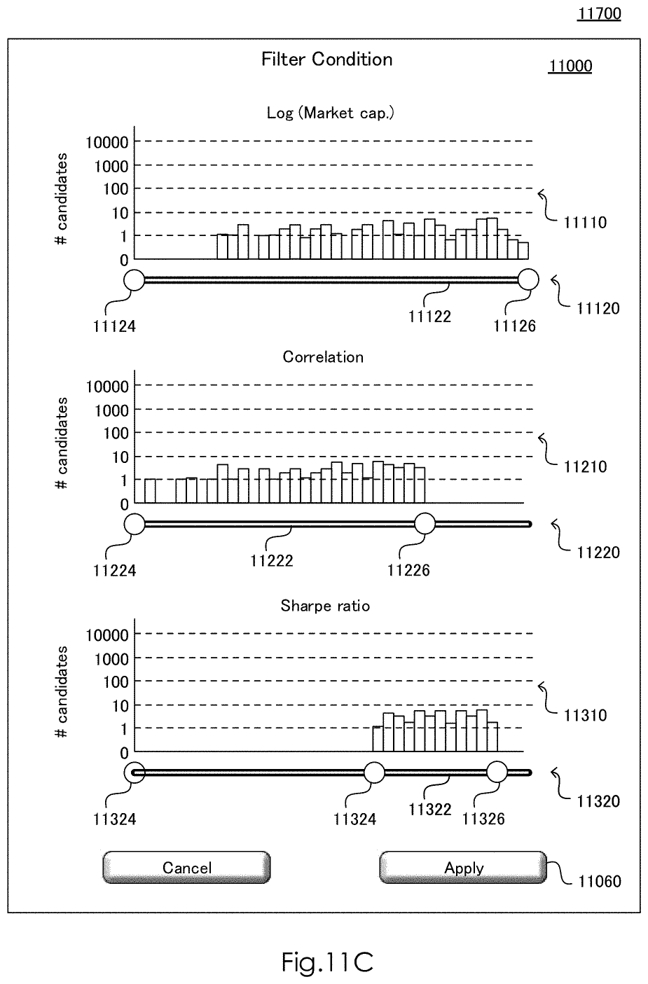

Referring back to FIG. 7B, when the type of input received in step S7220 is a filter set command input, the process proceeds to step S7250. In step S7250, controller 1120 sets and applies a filter condition to the list of security candidates. The details of set filter button 8218 are described below with reference to FIGS. 10, 11A, 11B, and 11C.

When the type of input received in step S7220 is a security select/deselect command input, the process proceeds to step S7260. In step S7260, controller 1120 changes the selection status of a target security candidate.

FIG. 8E shows an example of a screen image displayed by controller 1120 on display and input device 1110 in step S7210 after step S7260 of FIG. 7B. Check boxes 8214 in security candidates dialog window 8280 in screen 8270 show that the security candidates: ITF A, ITF B, ITF C, ITF D, and ETF A are currently selected, and that the security candidates: stock A, stock B, and stock C are not currently selected.

Referring back to FIG. 7B, when the type of input received in step S7220 is an add command input, the process proceeds to step S7270. In step S7270, controller 1120 adds one or more selected security candidates to the portfolios indicated by the current, ideal, and new portfolio information and the process subsequently exits the operation flow and returns to step S7020 of FIG. 7A.

Referring back to FIG. 7A, in step S7020, controller 1120 sends information indicating a combination of securities that were selected in step S7070 to ideal allocation calculator 1260 and receives information indicating an ideal allocation from ideal allocation calculator 1260. In step S7030, controller 1120 initializes the new portfolio information with the ideal portfolio information.

FIG. 8F shows an example of a screen image displayed by controller 1120 on display and input device 1110 in step S7040 of FIG. 7A after returning from step S7070 of FIG. 7A. For example, in screen 8300, information indicating component assets for the securities: ITF A, ITF B, ITF C, ITF D, and ETF A that were selected in step S7070 have been added to the current, ideal, and new portfolio information. Name fields 8010 and last traded price fields 8020 are updated using profile information that have been or are received by controller 1120 from security information manager 1230. Current ratio fields 8030 for newly added securities are initialized by controller 1120 to zero. Ideal ratio fields 8040 are updated by controller 1120 using information indicating the ideal allocation that has been received by controller 1120 from ideal allocation calculator 1260. New ratio fields 8050 are updated by controller 1120 using information indicating the new portfolio initialized in step S7030. Reference-currency-equivalent valuation fields 8070 are updated by controller 1120 using the total reference-currency-equivalent valuation and the ideal allocation, such that for each component security, the value of reference-currency-equivalent valuation field 8070 is equal to the total reference-currency-equivalent valuation multiplied by the value of new ratio field 8050. Newly holding quantity fields 8060 are updated by controller 1120 using the values in reference-currency-equivalent valuation and the last traded price fields 8020.

<Deletion of Component Securities>

Referring back to FIG. 7A, when the type of input received by controller 1120 in step S7050 is a security delete command input, the process proceeds to step S7080. In step S7080, controller 1120 executes a process for deleting one or more component securities from the portfolios indicated by the current, ideal, and new portfolio information.

Referring to FIG. 7B, in step S7210, controller 1120 shows a list of security candidates to be deleted from the portfolios indicated by the current, ideal, and new portfolio information. The security candidates to be deleted may be, for some example embodiments, all component securities included in the portfolios. Step S7220 of FIG. 7B for step S7080 in FIG. 7A are processed in the same manner as that for step S7070 of FIG. 7A, except that the types of input received by controller 1120 may include a delete command input for deleting one or more selected security candidates from the current, ideal, and new portfolio information, instead of an add command input. Steps S7230, S7240, S7250 and S7260 of FIG. 7B for step S7080 of FIG. 7A are processed in the same manner as those for step S7070 of FIG. 7A.

FIG. 8G shows an example of a screen image displayed by controller 1120 on display and input device 1110 in step S7210 after step S7260 of FIG. 7B. In one example embodiment, screen 8400 includes security candidates dialog window 8410. Security candidates for deletion are listed in security candidates dialog window 8410. For each security candidate for deletion, security candidates dialog window 8410 may show name label 8412 showing a name of the security candidate and check box 8414 showing whether the security candidate is currently selected by a user or not. Check boxes 8414 show that the security candidate: ITF D is currently selected, and that the security candidates: ITF A, ITF B, ITF C, and ETF A are not currently selected. The functions of name labels 8412 and check boxes 8414 are the same as those of name labels 8212 and check boxes 8214 of FIG. 8E. When security candidates dialog window 8410 is not large enough to show all the security candidates, the list of security candidates may be scrollable such that any security candidate in the list can be shown in security candidates dialog window 8410. Security candidates dialog window 8410 may further include delete button 8416. For example, a reception of the delete command input may be through a detection by controller 1120 of a tap or click on delete button 8416.

Referring back to FIG. 7B, when the type of input received in step S7220 is a delete command input, the process proceeds to step S7270. In step S7270, controller 1120 deletes one or more selected security candidates from the portfolios indicated by the current, ideal, and new portfolio information and the process subsequently exits the operation flow and returns to step S7020 of FIG. 7A. Steps S7020 and S7030 of FIG. 7A are subsequently executed in the same manner as that described above with regard to a security add command input.

FIG. 8H shows an example of a screen image displayed by controller 1120 on display and input device 1110 in step S7040 after returning from step S7080 of FIG. 7A. Compared to screen 8300 in FIG. 8E, name field 8010, last traded price field 8020, last traded date field 8025, current ratio field 8030, ideal ratio field 8040, new ratio field 8050, newly holding quantity field 8060, and reference-currency-equivalent valuation field 8070 for ITF D which was selected in step S7080, have been deleted from the current, ideal, and new portfolio information shown in screen 8500. Ideal ratio fields 8040, new ratio fields 8050, reference-currency-equivalent valuation fields 8070, and newly holding quantity fields 8060 have been updated in a manner similar to that described with regard to a security add command input.

In one example embodiment, fraction(s) of the purchase price may be rounded down when securities are purchased and fraction(s) of the sell price may be rounded up when securities are sold, both in favor of an investor. As a result, for example, as shown in FIG. 8H, the total reference-currency-equivalent valuation may be increased by an amount equivalent to the fraction(s). The same applies to other examples explained herein.

<Update of Constraint Parameter>

Referring back to FIG. 7A, when the type of input received by controller 1120 in step S7050 is a constraint parameter update command input, the process proceeds to step S7090. In step S7090, controller 1120 receives a value update input for a constraint parameter and updates the constraint parameter with the value indicated by the value update input. The process subsequently returns to step S7020.

FIG. 8I shows an example of a screen image displayed by controller 1120 on display and input device 1110 in step S7090 of FIG. 7A. Screen 8600 includes constraint parameter input pad 8610 for inputting a value of constraint parameter. Controller 1120 may determine the type of constraint parameter depending on the text shown on strategy label 8092. In this example, the constraint parameter is a target volatility. Constraint parameter input pad 8610 has a calculator-like interface equipped with numeric button widgets and is used to input numeric digits representing a value of constraint parameter. A value inputted via constraint parameter input pad 8610 may be used as a value update input in constraint parameter input field 8080. Although constraint parameter input pad 8610 is used here as an input method, any other suitable input method may be used to receive a value input by a user.

Referring back to FIG. 7A, in step S7020, controller 1120 sends information indicating a combination of component securities of the ideal portfolio together with information indicating one or more constraint parameters that were inputted in step S7090 to ideal allocation calculator 1260. Controller 1120 subsequently receives information indicating an ideal allocation from ideal allocation calculator 1260. In step S7030, controller 1120 initializes the new portfolio information with the ideal portfolio information.

FIG. 8J shows an example of a screen image displayed by controller 1120 on display and input device 1110 in step S7040 of FIG. 7A after step S7090. In screen 8700, constraint parameter input field 8080 has been updated with a value of 18% that was inputted via constraint parameter input pad 8610. Further, ideal ratio fields 8040 have been updated by an ideal allocation indicated by information that was received from ideal allocation calculator 1260 in step S7020. The ideal allocation was calculated using the value of 18% as a target volatility by ideal allocation calculator 1260. Further, new ratio fields 8050 have been updated with the ideal allocation. Similar scenario applies for other constraint parameters such as, for example, a target expectation of return and a risk-free rate. Thus, a user can specify acceptable constraint parameters, such as a target volatility, a target expectation of return, and a risk-free rate.

<Risk/Return Modification>

FIG. 8K shows another example of a screen image displayed on display and input device 1110 by controller 1120 in step S7040 of FIG. 7A. In one example embodiment, screen 8720 includes name fields 8010, actual return fields 8722 showing an actual expectation of return, specified return fields 8724 showing a specified expectation of return, actual risk fields 8726 showing an actual risk value, specified risk fields 8728 showing a specified risk value, current ratio fields 8030, ideal ratio fields 8040, new ratio fields 8050, constraint parameter input field 8080, strategy selection combo box 8090, and strategy label 8092. The functions of name fields 8010, current ratio fields 8030, ideal ratio fields 8040, new ratio fields 8050, constraint parameter input field 8080, strategy selection combo box 8090, and strategy label 8092 included in screen 8720 are the same as those included in screen 8000 of FIG. 8A. For the sake of simplicity, last traded price fields 8020, last traded date fields 8025, newly holding quantity fields 8060, reference-currency-equivalent valuation fields 8070 are omitted in screen 8720, however, these omitted fields may be present in screen 8720. For example, these omitted fields are placed together with name fields 8010, actual return fields 8722, specified return fields 8724, actual risk fields 8726, specified risk fields 8728, current ratio fields 8030, ideal ratio fields 8040, new ratio fields 8050 in a horizontally scrollable pane, and hidden fields may be shown after the pane is horizontally scrolled by a user.

Each name field 8010, actual return field 8722, specified return field 8724, actual risk field 8726, specified risk field 8728, current ratio field 8030, ideal ratio field 8040, new ratio field 8050 that are aligned in a row correspond to one component asset included in at least one of the current portfolio information, the ideal portfolio information, and the new portfolio information. In one example embodiment, actual return fields 8722 and actual risk fields 8726 are not user-editable and specified return fields 8724 and specified risk fields 8728 are user-editable. In one example, the values of specified expectations of return and specified risk values have been initialized with the values of actual expectations of return and actual risk values, respectively.

Referring back to FIG. 7A, in step S7050, controller 1120 receives an input by a user from display and input device 1110. The types of input may include, for example, a risk/return modify command input for modifying a risk value or an expectation of return of a target component security. For example, a reception of the risk/return modify command input may be through a detection by controller 1120 of a tap or click on actual return field 8722, specified return field 8724, actual risk field 8726, or specified risk field 8728.

When the type of input received by controller 1120 in step S7050 is a risk/return modify command input, the process proceeds to step S7095. In step S7095, controller 1120 receives a value update input for a specified expectation of return or a specified risk value of the target component security, and updates the specified expectation of return or a specified risk value with the value indicated by the value update input. The process subsequently returns to step S7020.

FIG. 8L shows an example of a screen image displayed by controller 1120 on display and input device 1110 in step S7095 of FIG. 7A. Screen 8750 includes risk/return input pad 8752 for inputting a value of a specified expectation of return or a specified risk value of the target component security. In this example, the target component security is ITF B. Risk/return input pad 8752 has a calculator-like interface equipped with numeric button widgets and is used to input numeric digits representing a value of a specified expectation of return or a specified risk value of the target component security. A value that is inputted via risk/return input pad 8752 may be used as a value update input in specified return field 8724 or specified risk field 8728. Although risk/return input pad 8752 is used here as an input method, any other suitable input method may be used to receive a value input by a user.

Referring back to FIG. 7A, in step S7020, controller 1120 sends information indicating a combination of component securities of the ideal portfolio together with information indicating a specified expectation of return and/or a specified risk value for each component security to ideal allocation calculator 1260. Controller 1120 subsequently receives from ideal allocation calculator 1260 information indicating an ideal allocation that was calculated using modified expectation of return and modified risk values described above. In step S7030, controller 1120 initializes the new portfolio information with the ideal portfolio information.

FIG. 8M shows an example of a screen image displayed by controller 1120 on display and input device 1110 in step S7040 of FIG. 7A after step S7095. In screen 8770, specified return field 8724 for the target component security: ITF B has been updated with a value of 20% that was inputted via risk/return input pad 8752. Further, ideal ratio fields 8040 have been updated by the ideal allocation indicated by information that was calculated using the specified expectation of return and risk values. Further, new ratio fields 8050 have been updated with the ideal allocation.

One of the inventors found that, while expectations of return and risk values of securities significantly depend on the market trends, variations in correlation coefficients between security pairs are relatively small for many securities when the correlation coefficients are calculated using scaled expectations of return and scaled risk values. Thus, by enabling the calculation of ideal allocations using specified expectations of return and risk values, a user can determine ideal allocations that are more in line with the current or anticipated market trends.

<New Ratio Update>

Referring back to FIG. 7A, when the type of input received by controller 1120 in step S7050 is a new ratio update command input, the process proceeds to step S7100. In step S7100, controller 1120 receives a value update input for a new ratio of the target component asset valuation, and updates the ratio indicated by the new portfolio information with the value indicated by the value update input. The process subsequently returns to step S7040.

FIG. 8N shows an example of a screen image displayed by controller 1120 on display and input device 1110 in step S7100. Screen 8800 includes new ratio input pad 8810 for inputting a new ratio of a target component asset valuation. In this example, the target component security is ITF C. New ratio input pad 8810 has a calculator-like interface equipped with numeric button widgets and is used to input numeric digits representing a new ratio of the target component asset valuation. The value inputted via new ratio input pad 8810 may be used as a value update input in user-editable new ratio field 8050 for the target component security. Although new ratio input pad 8810 is used here as an input method, any other suitable input method may be used to receive a value input by a user.

FIG. 8O shows an example of a screen image displayed by controller 1120 on display and input device 1110 in step S7040 of FIG. 7A after step S7100. On screen 8900, new ratio field 8050 for the target component security: ITF C is updated to 50% that has been input via new ratio input pad 8810. Further, new ratio field 8050 for the reference currency: Japanese yen is updated to 6.77% that is a change in the value in new ratio field 8050 for ITF C between before and after step S7100. Thus, the currency asset valuation is updated such that the total valuation of the new portfolio is unchanged. Step S7100 may be repeated to assign the 6.77% portion of the total asset valuation to other component securities: ITF A, ITF B, and/or ETF A, thereby a user can reflect a desired allocation of component securities in the new portfolio information.

<Display of Effective Frontier Chart>

Referring back to FIG. 7A, when the type of input received by controller 1120 in step S7050 is an effective frontier display command input, the process proceeds to step S7105. In step S7105, controller 1120 sends information indicating the combination of component securities of the ideal portfolio to effective frontier generator 1270. Effective frontier generator 1270 subsequently generates image data of an effective frontier chart. Controller 1120 subsequently receives the image data from effective frontier generator 1270, and displays or renders an effective frontier chart on display and input device 1110.

FIG. 8P shows an example of a screen image displayed by controller 1120 on display and input device 1110 in step S7105 of FIG. 7A. Screen 9000 includes effective frontier chart 9010. In one example embodiment, the horizontal axis and the vertical axis of effective frontier chart 9010 correspond to a risk value and an expectation of return, respectively. The risk value may be an annualized volatility. The expectation of return may be an annualized return. In one example, effective frontier chart 9010 may include points 9012a, 9012b, 9012c, and 9012d, which correspond to the component securities: ITF A, ITF B, ITF C, and ITF D of the ideal portfolio, respectively. Effective frontier chart 9010 further includes points 9014, each of which corresponds to a portfolio having a random allocation to the component securities: ITF A, ITF B, ITF C, and ITF D of the ideal portfolio. Effective frontier chart 9010 further includes point 9016 which corresponds to the ideal portfolio. In this example, point 9016 corresponds to the ideal portfolio having the maximum expectation of return under the condition that the risk value is equal to or less than 18.0%. Points 9014 may be color-coded according to the Sharpe ratio.

<Display of Expected Return Histogram>

Referring back to FIG. 7A, when the type of input received by controller 1120 in step S7050 is an expected return histogram display command input, the process proceeds to step S7110. In step S7110, controller 1120 sends information indicating the ideal portfolio and/or the new portfolio to return histogram generator 1280. Return histogram generator 1280 subsequently generates information indicating a return histogram and controller 1120 subsequently receives the information from return histogram generator 1280. In one example embodiment, the information indicating a return histogram includes image data of a return histogram. Controller 1120 subsequently displays or renders a return histogram chart on display and input device 1110.

FIG. 8Q and FIG. 8R show an example of a screen image displayed by controller 1120 on display and input device 1110 in step S7110 of FIG. 7A. Screen 9100 in FIG. 8Q includes return histogram 9110. Screen 9200 in FIG. 8R includes return histogram 9210. Histograms 9110 and 9210 shows a probability distribution of the expectations of cumulative returns of the new portfolio after one year and three years, respectively. This corresponds to an assumption that a user usually performs portfolio rebalancing at every duration of one year or three years. Any length of duration may be used instead. The process subsequently returns to step S7040 in FIG. 7A.

<Save New Portfolio Information>

Referring back to FIG. 7A, when the type of input received by controller 1120 in step S7050 is a new portfolio information save command input, the process proceeds to step S7120. In step S7120, controller 1120 sends information indicating the new portfolio to portfolio information manager 1220. Portfolio information manager 1220 subsequently stores the information. Portfolio information manager 1220 may store the information with associating information indicating a name of the new portfolio. Portfolio information manager 1220 may overwrite currently saved information by newly saved information. The information stored here may be sent to controller 1120 as portfolio information in step S2066 of FIG. 3 at the next execution of the application. The process subsequently returns to step S7040 in FIG. 7A.

<Logout>

Referring back to FIG. 7A, when the type of input received by controller 1120 in step S7050 is a logout command input, the user is logged out and the process exits the operation flow.

<Application of Filter Condition>

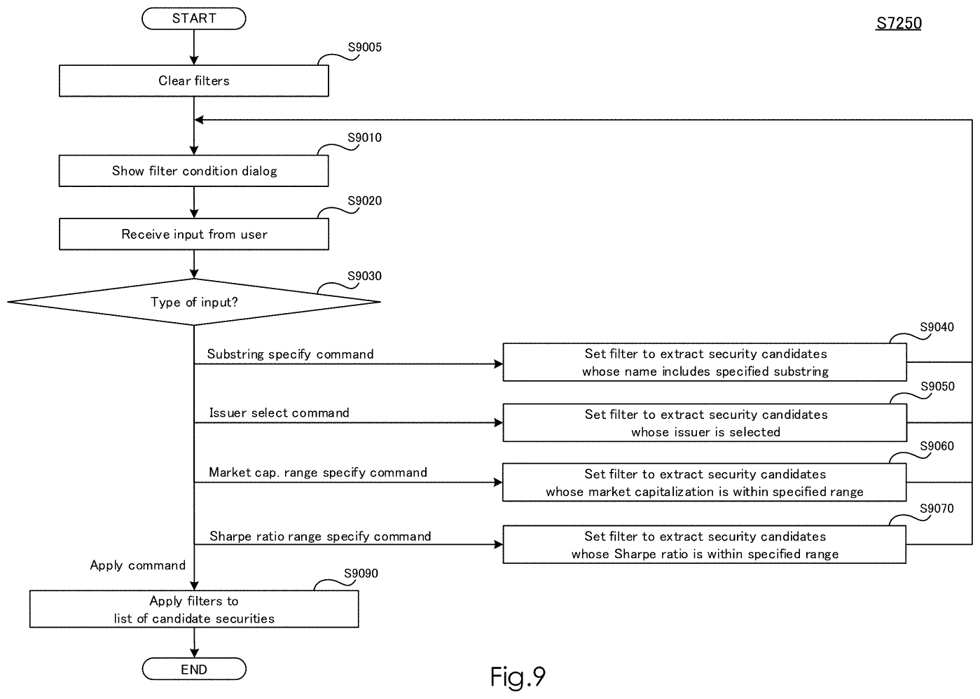

FIG. 9 shows an example of an operation flow diagram executed by controller 1120 of client 1100 in step S7250 of FIG. 7B.

In step S9005, controller 1120 initializes a filter condition. The filter condition may be a condition defined by a combination of multiple filters, each of which corresponds to a filter set by controller 1120 in each of steps S9040, S9050, S9060, and S9070. In one example embodiment, controller 1120 may initialize a filter condition by clearing the filters.

In step S9010, controller 1120 displays information indicating a list of security candidates on display and input device 1110.

FIG. 10 shows an example of a screen image displayed on display and input device 1110 by controller 1120 in step S9010 of FIG. 9. In one example embodiment, screen 10000 includes filter condition dialog box 10005. Filter condition dialog box 10005 includes substring input field 10010 for inputting a substring to filter names of security candidates for addition or deletion, matching method selection combo box 10015 for selecting a matching method used for filtering names of security candidates, issuer selection combo box 10020 for selecting an issuer of security candidates, market capitalization range input fields 10032 and 10034 for inputting a lower and/or an upper bound value to specify a range of market capitalization, market capitalization currency unit selection combo box 10036 for selecting a currency unit that is used for representing the market capitalization, correlation range input fields 10042 and 10044 for inputting a lower bound and/or an upper bound to specify a range of correlation coefficient, correlation target portfolio selection combo box 10046 for selecting a target portfolio used to calculate a correlation coefficient from the current, ideal, or new portfolio, Sharpe ratio range input fields 10052 and 10054 for inputting a lower bound and/or an upper bound to specify a range of the Sharpe ratio, and apply button 10060 for applying filters to the list of security candidates. Substring input field 10010, market capitalization range input fields 10032 and 10034, correlation coefficient range input fields 10042 and 10044, and Sharpe ratio range input fields 10052 and 10054 may be all user-editable. Filter condition dialog box 10005 may further include interface for inputting values related to any kinds of statistical parameters and used to filter security candidates for addition or deletion. The statistical parameters may be, for example, an expectation of return, a risk value, correlation coefficients between security candidates.

In step S9020, controller 1120 receives an input by a user from display and input device 1110. The types of input may include, for example, a substring specify command input for specifying a substring to extract one or more security candidates whose name includes the substring, an issuer select command input for selecting one or more issuers to extract one or more security candidates whose issuer is selected, a market capitalization range specify command input for specifying a market capitalization range to extract one or more security candidates whose market capitalization is within the specified range, a Sharpe ratio range specify command for specifying a Sharpe ratio range to extract security candidates whose Sharpe ratio is within the specified range, and an apply command for applying filters to the list of candidate securities used in step 7210 of FIG. 7B. For example, a reception of the substring specify command input may be through a detection by controller 1120 of an input of a substring in substring input field 10010. For example, a reception of the issuer select command input may be through a detection by controller 1120 of a selection of a menu item indicating an issuer in issuer selection combo box 10020. For example, a reception of the market capitalization range specify command input may be through a detection by controller 1120 of an input of a lower and/or an upper bound value in market capitalization range input fields 10032 and 10034. For example, a reception of the Sharpe ratio range specify command may be through a detection by controller 1120 of an input of a lower/and or an upper bound value in Sharpe ratio range input fields 10052 and 10054. For example, a reception of the apply command may be through a detection by controller 1120 of a tap or click on apply button 10060.

Referring back to FIG. 9, in step S9030, controller 1120 determines the type of input received in step S9020. When the type of input received by controller 1120 in step S9020 is a substring specify command input, the process proceeds to step S9040. In step S9040, controller 1120 sets a filter to extract one or more security candidates whose name includes a substring specified by the substring specify command input. The process subsequently returns to step S9010.

When the type of input received by controller 1120 in step S9020 is an issuer select command input, the process proceeds to step S9050. In step S9050, controller 1120 sets a filter to extract one or more security candidates whose issuer is selected by the issuer select command input. The process subsequently returns to step S9010.

When the type of input received by controller 1120 in step S9020 is a market capitalization range specify command input, the process proceeds to step S9060. In step S9060, controller 1120 sets a filter to extract one or more security candidates whose market capitalization is within a range specified by the market capitalization range specify command input. The process subsequently returns to step S9010.

When the type of input received by controller 1120 in step S9020 is a Sharpe ratio range specify command, the process proceeds to step S9070. In step S9070, controller 1120 sets a filter to extract security candidates whose Sharpe ratio is within a range specified by the Sharpe ratio range specify command. The process subsequently returns to step S9010.

When the type of input received by controller 1120 in step S9020 is an apply command, the process proceeds to step S9090. In step S9090, controller 1120 applies the filters to the list of security candidates. The process subsequently exits the operation flow.

In the example shown in FIG. 10, the ranges are specified by a direct input of a lower and/or an upper bound value in the input fields. However, the ranges may be specified via any other suitable type of interface. For example, for two or more attributes of security candidates, controller 1120 may render on display and input device 1110 two or more pairs of a distribution histogram of security candidates that are listed in a list of security candidates for addition/deletion and a user interface. Each pair of the two or more pairs corresponds to an attribute of the two or more attributes. Examples of the attribute are, market capitalization, correlation coefficient, the Sharpe ratio, annualized return, and annualized volatility. For each pair of the two or more pairs, the distribution histogram is a distribution histogram over a value of the attribute corresponding to the pair. The length of bars of each distribution histogram may represent a frequency itself of a bin, or log (frequency+1) for a frequency of a bin, where the logarithm may be a logarithm with base 10. For each pair of the two or more pairs, the user interface is configured to show a range of values of the attribute corresponding to the pair and is configured such that the range can be specified by a user. Controller 1120 receives a range input indicating a specified range from the user interface. For example, the user interface may be a range slider. Controller 1120 subsequently updates the list of security candidates by extracting security candidates that satisfy a condition. The condition is that, for an attribute of each pair of the two or more pairs, the value of the attribute of the security candidates is within the specified range of values of the attribute. Controller 1120 subsequently updates the distribution histogram of each pair.

FIG. 11A shows another example of a screen image displayed or rendered on display and input device 1110 by controller 1120 in step S9010 of FIG. 9. Screen Filter condition dialog box 11000 includes market capitalization range slider 11122 for inputting a range of market capitalization, correlation coefficient range slider 11222 for inputting a range of correlation coefficient, Sharpe ratio range slider 11322 for inputting a range of the Sharpe ratio, and apply button 11060 for applying filters to the list of security candidates. The functions of apply button 11060 are the same as those of apply button 10060.

For the sake of simplicity, interfaces corresponding to substring input field 10010, matching method selection combo box 10015, issuer selection combo box 10020, market capitalization currency unit selection combo box 10036, correlation target portfolio selection combo box 10046 of filter condition dialog box 10005 that were described with referring to FIG. 10 are not shown in filter condition dialog box 11000, however, filter condition dialog box 11000 may include these widgets, as well.

Filter condition dialog box 11000 further includes distribution histogram 11110 which is shown above capitalization range slider 11122. The horizontal axis of distribution histogram 11110 is, for example, a logarithm of market capitalization. The vertical axis of distribution histogram 11110 is, for example, a number of security candidates for addition/deletion in a logarithmic scale. Track 11122 may be placed parallel to the horizontal axis of distribution histogram 11110. A range determined by the positions of sliders 11124 and 11126 on track 11124 may corresponds to a range in the horizontal axis of distribution histogram 11110. In response to a detection of movement of at least one of two sliders 11124 and 11126, controller 1120 may receive information indicating the positions of two sliders 11124 and 11126, determine a range in the horizontal axis of distribution histogram 11110 based on the range determined by the positions of sliders 11124 and 11126, and determine a range in market capitalization.

Filter condition dialog box 11000 further includes distribution histogram 11210 which is shown above capitalization range slider 11222. The horizontal axis of distribution histogram 11210 is, for example, a correlation coefficient. The vertical axis of distribution histogram 11210 is, for example, a number of security candidates for addition/deletion in a logarithmic scale. Track 11222 may be placed parallel to the horizontal axis of distribution histogram 11210. A range determined by the positions of sliders 11224 and 11226 on track 11224 may corresponds to a range in the horizontal axis of distribution histogram 11210. In response to a detection of movement of at least one of two sliders 11224 and 11226, controller 1120 may receive information indicating the positions of two sliders 11224 and 11226, determine a range in the horizontal axis of distribution histogram 11210 based on the range determined by the positions of sliders 11224 and 11226, and determine a range in correlation coefficient.

Filter condition dialog box 11000 further includes distribution histogram 11310 which is shown above capitalization range slider 11322. The horizontal axis of distribution histogram 11310 is, for example, the Sharpe ratio. The vertical axis of distribution histogram 11310 is, for example, a number of security candidates for addition/deletion in a logarithmic scale. Track 11322 may be placed parallel to the horizontal axis of distribution histogram 11310. A range determined by the positions of sliders 11324 and 11326 on track 11324 may corresponds to a range in the horizontal axis of distribution histogram 11310. In response to a detection of movement of at least one of two sliders 11324 and 11326, controller 1120 may receive information indicating the positions of two sliders 11324 and 11326, determine a range in the horizontal axis of distribution histogram 11310 based on the range determined by the positions of sliders 11324 and 11326, and determine a range in the Sharpe ratio.

In response to a determination by controller 1120 of a range in market capitalization, correlation coefficient, or the Sharpe ratio, controller 1120 may extract security candidates whose market capitalization, correlation coefficient, and the Sharpe ratio are within the respective determined ranges, and updates all distribution histograms 11110, 11210, and 11310 with respective distribution histograms of the extracted security candidates.

FIG. 11B shows another example of a screen image displayed or rendered on display and input device 1110 by controller 1120 in step S9010 of FIG. 9. In screen 11600, a user has moved slider 11226. In response to a detection of the movement of slider 11226, security candidates whose market capitalization, correlation coefficient, and the Sharpe ratio are within the respective determined ranges are extracted by controller 1120. Controller 1120 subsequently updates all distribution histograms 11110, 11210, and 11310 accordingly

FIG. 11C shows another example of a screen image displayed or rendered on display and input device 1110 by controller 1120 in step S9010 of FIG. 9. In screen 11700, the user has subsequently moved sliders 11324 and 11326 after moving slider 11226. In response to a detection of the movement of sliders 11324 and 11326, security candidates whose market capitalization, correlation coefficient, and the Sharpe ratio are within the respective determined ranges are extracted by controller 1120. Controller 1120 updates all distribution histograms 11110, 11210, and 11310 accordingly.

Although market capitalization, correlation coefficient, or the Sharpe ratio are used as an attribute of security candidates to be counted in the distribution histogram in the example described above, any kind of attribute of objects to be counted that can be parameterized by a value may be used, as well. By using the method described above, a user can extract suitable security candidates from tens or more thousands of security candidates in a more intuitive manner.

### Other Embodiments

An advertisement may be displayed on screens shown in the drawings, for example, screen 8000 showing new allocation editor of FIG. 8A, screen 9000 showing effective frontier chart 9010 of FIG. 8P.

Although yen-equivalent valuations are used in some embodiments as reference-currency-equivalent valuations, dollar-equivalent valuations, euro-equivalent valuations, or other currency-equivalent valuations may be used instead. Further, US dollar is categorized herein as a component currency, however, embodiments of the present invention applies in a similar manner when any component currency but a reference currency is regarded as a component security.

For the sake of simplicity, a security add command input and a security delete command input which are described with referring to steps S7080 and S7090 in FIGS. 7A and 7B are not listed in the type of input processed in step S5030, these command inputs can be processed in step S5030 in a similar manner to those processed in steps S7080 and S7090.

Although the present invention has been described using a client-server configuration as an example, any function described herein may be realized on any computer. For example, all functions of the client 1100 and all functions of the server 1200 may be realized by a single computer having a single processor and memory.

A program according to the present invention may further implement functions to perform data analysis on investor's portfolio data collected via the app in combination with the investor's customer attributes.

The present invention is described herein with referring to operation flow diagrams showing an example of processing flow, however, the steps included in the flow diagrams may be omitted, interchanged in sequence, or executed in parallel, as long as equivalent results can be obtained.

In this specification, A and/or B means at least one of A, B, A and B.

Although some embodiments of the present invention have been described above, they are presented as an example and are not intended to limit the scope of the present invention. These novel embodiments can be implemented in various other forms, and various omissions, substitutions, and modifications can be made to the extent that they do not depart from the main purpose of the present invention. These embodiments and variations thereof are included in the scope and spirit of the present invention, as well as within the scope of the invention defined by the claims and equivalents thereof.

1. A method performed by a processor, the method comprising:
showing a set of security candidates on a display device;
receiving from an input device a selection input indicating a selection of two or more securities to be added to an ideal portfolio from the set of security candidates;
adding the two or more securities to the ideal portfolio;
determining an ideal allocation for the ideal portfolio such that an ideal expectation of return of the ideal portfolio and an ideal risk value indicating a magnitude of variation in the return of the ideal portfolio satisfy a predefined condition; and
showing the ideal allocation on the display device.

2. The method of claim 1,
wherein the ideal expectation of return and the ideal risk value are calculated using respective actual expectations of return of the two or more securities, respective actual risk values indicating a magnitude of variation in the return of the two or more securities, and first coefficients indicating joint variability in the respective returns of the two or more securities,
wherein the actual expectations of return, the actual risk values, and the first coefficients are calculated using historical price data of the two or more securities.

3. The method of claim 2, wherein the first coefficients comprise one of (i) elements of a variance-covariance matrix calculated using historical price data of the two or more securities and (ii) elements of a correlation matrix calculated using historical price data of the two or more securities.

4. The method of claim 1, further comprising:
receiving from the input device at least one of a specified expectation input indicating a specified expectation of return and a specified risk value input indicating a specified risk value, for at least one of the two or more securities,
wherein the ideal expectation of return and the ideal risk value are calculated using (i) the specified expectation of return for the at least one of the two or more securities, (ii) the specified risk value for the at least one of the two or more securities, (iii) respective actual expectations of return of the two or more securities for which the specified expectation of return is not inputted, (iv) respective actual risk values indicating a magnitude of variation in the return of the two or more securities for which the specified risk value is not inputted, and (v) second coefficients indicating joint variability in the returns of the two or more securities,
wherein the actual expectations of return, the actual risk values, and the second coefficients are calculated using historical price data of the two or more securities.

5. The method of claim 4, wherein the second coefficients comprise elements of a correlation matrix calculated using historical price data of the two or more securities.

6. The method of claim 5,
wherein the ideal risk value comprises one of a standard deviation of return and a downward standard deviation of return.

7. The method of claim 1,
wherein the predefined condition is one of (i) the ideal expectation of return is maximized under a condition that the ideal risk value is within a predetermined range and (ii) the ideal risk value is minimized under a condition that the ideal expectation of return is within a predetermined range.

8. The method of claim 1,
wherein the predefined condition is a condition that a value of a function is maximized or minimized for the ideal expectation of return and the ideal first risk within respective predetermined ranges.

9. The method of claim 8,
wherein the function is a Sharpe ratio whose value is calculated from the ideal expectation of return and the ideal risk value.

10. The method of claim 1, further comprising:
for two or more attributes of security candidates, rendering on the display device two or more pairs of a distribution histogram of a set of security candidates and a user interface, each pair corresponding to an attribute of the two or more attributes, the distribution histogram of each pair being a distribution histogram over a value of the attribute corresponding to the pair, the user interface of each pair being configured to show a range of values of the attribute corresponding to the pair, the range being specified in response to a range input by the user on the input device;
in response to the range having been specified, updating the set of security candidates by extracting security candidates that satisfy a condition that, for an attribute of each pair of the two or more pairs, the value of the attribute of the security candidates is within the specified range of values of the attribute; and
updating the distribution histogram on the display device for each pair of the two or more pairs.

11. The method of claim 10,
wherein the user interface comprises a range slider having two sliders that can be manipulated by a user to input a range input,
wherein the two or more attributes comprise at least one of a market capitalization, a correlation coefficient, a Sharpe ratio, an annualized return, and an annualized volatility.

12. The method of claim 1, further comprising:
receiving a quantity input indicating a currency quantity;
updating a currency quantity of a current portfolio with the currency quantity indicated by the quantity input; and
initializing the ideal portfolio with the current portfolio.

13. A method according to claim 12, further comprising:
receiving an investor identification input identifying an investor;
receiving a portfolio identification input identifying portfolio information that is associated with the investor;
loading the portfolio information from a memory; and
initializing the current portfolio using the portfolio information.

14. The method of claim 1, further comprising:
initializing new portfolio with the ideal portfolio;
receiving a ratio input indicating a ratio of an asset valuation for one of the two or more securities;
updating the new portfolio such that the ratio of the asset valuation of the one of the two or more securities to the valuation of the new portfolio is equal to the ratio indicated by the ratio input; and
showing new allocation of the new portfolio on the display device.

15. The method of claim 14,
wherein, when the asset valuation of the one of the two or more securities decreases in the updating, updating a currency asset valuation of the new portfolio such that the total valuation of the new portfolio is unchanged.

16. The method of claim 14, further comprising:
storing portfolio information indicating the new portfolio in a memory with associating with an investor.

17. The method of claim 1,
wherein the ideal allocation is determined by:
calculating pairs of an expectation of return and a risk value, respectively for randomly generated allocations for the two or more securities; and
selecting an allocation from the allocations whose expectation of return and risk value satisfy the predefined condition.

18. The method of claim 16, further comprising:
rendering an effective frontier chart using the pairs of an expectation of return and a risk value.

19. A system comprising:
a processor; and
a non-transitory computer readable memory storing a program code configured to, when executed by the processor, cause the processor to perform a method comprising:
showing a set of security candidates on a display device;
receiving from an input device a selection input indicating a selection of two or more securities to be added to an ideal portfolio from the set of security candidates;
adding the two or more securities to the ideal portfolio;
determining an ideal allocation for the ideal portfolio such that an ideal expectation of return of the ideal portfolio and an ideal risk value indicating a magnitude of variation in the return of the ideal portfolio satisfy a predefined condition; and
showing the ideal allocation on the display device.

20. A computer program product comprising:
a non-transitory computer readable medium having a program code embodied therein configured to, when executed by a processor, cause the processor to perform a method comprising:
showing a set of security candidates on a display device;
receiving from an input device a selection input indicating a selection of two or more securities to be added to an ideal portfolio from the set of security candidates;
adding the two or more securities to the ideal portfolio;
determining an ideal allocation for the ideal portfolio such that an ideal expectation of return of the ideal portfolio and an ideal risk value indicating a magnitude of variation in the return of the ideal portfolio satisfy a predefined condition; and
showing the ideal allocation on the display device.
